(19) United States
(12) Patent Application Publication
(10) Pub. No.: US 2017/0113940 A1
(43) Pub. Date: Apr. 27, 2017

(54) METHOD FOR ALUMINUM INCORPORATION INTO HIGH-SILICA ZEOLITES PREPARED IN FLUORIDE MEDIA

(71) Applicant: JOHNSON MATTHEY PLC, London (GB)

(72) Inventors: RAUL F. LOBO, NEWARK, DE (US); Takahiko Moteki, Savoy, IL (US)

(21) Appl. No.: 15/299,500

(22) Filed: Oct. 21, 2016

Related U.S. Application Data
(60) Provisional application No. 62/244,795, filed on Oct. 22, 2015.

(51) Int. Cl. C01B 39/46

(52) U.S. Cl. CPC C01B 39/46

(57) ABSTRACT

A method of synthesizing high-silica zeolites in a fluoride media using faujasite crystals as the aluminum source and quasi-siliceous seed crystals containing a small amount of germanium is described. The faujasite crystals dissolved during hydrothermal treatment, prior to the crystallization of LTA-type zeolites. High-silica zeolites of an LTA, a CHA, a *BEA and an STT-type were produced. High-silica zeolites with a Si/Al ratio (SAR) of 63 to 420 were synthesized, with the SAR related to the amount of faujasite crystals used. The aluminosilicate LTA-type zeolite products possess nearly defect-free structures, a characteristic often seen in fluoride mediated synthesis. The unit cell volumes of the high-silica LTA-type zeolites correspond to the amount of Al present in the framework. Aluminosilicate ITW-type zeolites were produced using these methods.

### FIELD OF THE INVENTION

The invention relates to methods of making zeolites in fluoride media having high-silica to alumina ratios (SAR) using quasi-siliceous seed crystals of the desired zeolite structure and crystals of a different zeolite structure as alumina source for the desired crystal phase.

### BACKGROUND OF THE INVENTION

Zeolites are crystalline or quasi-crystalline tectosilicates constructed of repeating TO₄ tetrahedral units with T being most commonly Si, Al or P (or combinations of tetrahedral units). These units are linked together through an apical oxygen to form frameworks having regular intra-crystalline cavities and/or channels of molecular dimensions. The specific sizes and shapes of the zeolites affect the selectivity of the zeolites in catalyst and separation applications and are two of the representative and valuable properties of zeolites. Numerous types of synthetic zeolites have been synthesized with each having a specific framework based on the arrangement of its tetrahedral units. By convention, each topological type is assigned a unique three-letter code (e.g., “AEI”, “CHA” or LTA”) by the International Zeolite Association (IZA). Aluminosilicate zeolites have been classified according to their silica (SiO₂) to alumina (Al₂O₃) ratio (SAR) with an SAR≦2 being low, a SAR>2 and ≦5 being intermediate and an SAR>5 being high, where these values are based on the molar ratios. When these values are based upon the ratios of the corresponding oxides, a low SAR is ≦4, an intermediate SAR is >4 and ≦10, and a high SAR is >10. The SAR values, as used herein, are based on the oxide ratios, unless specifically described as being based on the molar ratios. Some zeolites can be prepared in their “pure-silica” form, that is, with only SiO_{4/2} in tetrahedral positions. Some zeolite structures have only been prepared in their pure-silica form. One important synthetic challenge is to incorporate catalytically active sites, such as aluminum atoms, into these zeolite frameworks.

Zeolites have numerous industrial applications, and zeolites of certain frameworks, such as AEI and CHA, are known to be effective catalyst for NO and NO₂ abatement after the combustion exhaust gas in industrial applications including internal combustion engines, gas turbines, coal-fired power plants, and the like. In one example, nitrogen oxides (NOₓ) in the exhaust gas may be controlled through a so-called selective catalytic reduction (SCR) process whereby NOₓ compounds in the exhaust gas are contacted with a reducing agent, such as ammonia, in the presence of a zeolite catalyst.

Many topological types of synthetic zeolites when prepared as aluminosilicate compositions are produced using structure directing agents (SDAs), also referred in the art of zeolite synthesis to as a “templates” or “templating agents”. The SDAs that are used in the preparation of these synthetic zeolites are typically complex organic molecules that guide or direct the nucleation and growth of a specific zeolite structure. Generally, the SDA can be considered as a mold around which the zeolite micropores form and is occluded in the crystals during the crystallization reaction. After the crystals are formed, the SDA is typically removed from the interior structure of the crystals by oxidation at high temperatures in, for example, air, leaving a molecularly sized porous aluminosilicate cage.

In typical synthesis techniques, solid zeolite crystals precipitate from a reaction mixture which contains the framework components (e.g., a source of silica and a source of alumina), a source of hydroxide ions (e.g., NaOH), and an SDA. Such synthesis techniques usually take several days (depending on factors such as crystallization temperature or mixing rate) to achieve the desired crystallization. When crystallization is complete, the precipitate containing the zeolite crystals is separated by filtration from the mother liquor which is discarded.

The use of the fluoride anion as mineralizer was an important breakthrough in zeolite synthesis and an effective approach to the synthesis of novel zeolites. The zeolites obtained have a unique set of properties such as a very high Si/Al ratio, larger crystal size, less framework defects and hydrophobic properties. These properties originate from the presence of fluoride anion in the reaction gel and in the final product. However, new zeolites synthesized in fluoride media can often be only prepared in their pure-silica form, that is, they are difficult to obtain as aluminosilicates, reducing their potential as catalysts. For these reasons, an effective method for the introduction of aluminum into the final product of these fluoride syntheses would be very helpful to increase their compositional range and their potential for applications.

The first pure-silica and high-silica (Si/Al ratio of 47) LTA-type zeolites (ITQ-29) were synthesized in fluoride media. There is, however, a difficulty in the reproducible synthesis of high-silica aluminosilicate ITQ-29. In the synthesis of ITQ-29, a self-assembled organic structure-directing agent (SDA) dimer is occluded in the a-cages of the LTA structure and a second organic SDA, tetramethylammonium (TMA) cation, is occluded in the small-cages (sodalite- or (3-cages). Because two different organic SDAs are involved in the synthesis, the product formed is sensitive to impurities in the SDAs and/or minor changes in the synthesis conditions. Although several reports have attempted to develop more reproducible syntheses, only a handful have succeeded in the synthesis of pure-silica or aluminosilicate ITQ-29. For example, ultra-high-silica ITQ-29 (Si/Al ratio larger than 110) was obtained by adding aluminosilicate seed crystals in the siliceous reaction gel. The reproducible synthesis of pure-silica ITQ-29 has been also reported using the crown ether “Kryptofix 222” as an organic SDA. However there do not appear to be any reports on the successful synthesis of aluminosilicate ITQ-29 with Si/Al ratio of 47 or lower.

The selection of the aluminum source is an important factor affecting the synthesis and properties of many zeolite products. Among various kinds of aluminum sources utilized in the zeolite synthesis, aluminosilicate zeolites, especially the FAU-type zeolites, have been used as a source of aluminum in some cases. This approach has often been used in the hydroxide mediated synthesis of zeolites, a method that has been used for over 50 years to prepare high-silica zeolites. There are very few examples of this approach being used in fluoride mediated synthesis, a different technique that has been used for about 20 years, and can be more complex than hydroxide mediate synthesis. In the case of ITQ-29, aluminum isopropoxide, a common aluminum source, was used in the original study. Later on, nano-sized aluminosilicate LTA-type zeolite crystals with a low SAR (Al-rich) were used as seeds and also the source of aluminum of the final crystals to produce LTA-type material with an SAR of 110 to 2400. The use of the low SAR LTA-type seed as a source of Al provided a limit to the SAR values of the LTA-type product that can be produced.

It would be desirable to design a method of producing high SAR zeolites that are produced using a zeolite of a different type along with seed crystals of the desired type to produce new zeolites have different SAR values. This invention satisfies this need amongst others.

### SUMMARY OF THE INVENTION

High-silica zeolites can be synthesized in a fluoride media using crystals of a first zeolite as the aluminum source and quasi-siliceous seed crystals, containing for instance a very small amount of germanium, of a second zeolite. The first zeolite can have a framework type FAU, GME, LTA, MOR. The seed crystals can contain a second zeolite having an LTA, CHA, *BEA, or STT framework-type.

Aluminosilicate zeolites with LTA, CHA, *BEA, and STT framework-types and high SARs have been synthesized using the procedures described herein. Aluminosilicate ITW type zeolites have also been synthesized.

The new high SAR zeolites can be used as catalysts in reducing emissions in the exhaust gas of combustion engines, in hydrocarbon conversion reactions such as isomerizations, aromatizations, and alkylations, and cracking reactions.

### BRIEF DESCRIPTION OF THE DRAWINGS

FIG. 1 is a schematic illustration of the synthesis procedure for the formation of high-silica LTA-type zeolites.

FIG. 2 shows the XRD patterns of as-made Ge-ITQ-29 and as-made quasi-siliceous seed crystals.

FIG. 3 shows SEM images of quasi-siliceous seed crystals.

FIG. 4 shows XRD patterns of samples synthesized with various amounts of faujasite crystals.

FIG. 5 shows SEM images of calcined pure-silica and aluminosilicate LTA samples synthesized with (a) 10 and (b) 5 wt. % of faujasite crystals.

FIG. 6 shows SEM images of synthesized high-silica LTA-type zeolites.

FIG. 7 shows N₂ adsorption isotherms of the synthesized high-silica LTA-type zeolite sample.

FIG. 8 shows the XRD pattern of a product synthesized from siliceous reactant gel without seed crystals.

FIG. 9 shows the XRD pattern of products synthesized from aluminosilicate gel with seed crystal using aluminum isopropoxide as aluminum source.

FIG. 10 shows the ²⁹Si (a) and ²⁷Al (b) solid-state MAS NMR spectra, respectively, of the LTA samples synthesized without or with 10 wt. % of faujasite crystals.

FIG. 11 shows the solid-state ²⁹Si MAS NMR spectrum of faujasite crystals.

FIG. 12 shows the relationship between the unit cell volume and the aluminum content of the synthesized high-silica LTA-type zeolites and commercial zeolite 4A.

FIG. 13 shows XRD patterns of as-made samples synthesized with 10 wt. % of faujasite crystals for different hydrothermal reaction time.

FIG. 14 shows the ²⁹Si (a) and ²⁷Al (b) solid-state MAS NMR spectra of the sample synthesized with 10 wt. % of faujasite crystals for different hydrothermal treatment time.

FIG. 15 show the UV-vis spectra of the as-made samples synthesized with 10 wt. % of faujasite crystals for different time scales. A spectrum of a concentrated SDA solution (about 0.3 M) in included in the figure.

FIG. 16 shows XRD patterns of pure-silica seed and synthesized aluminosilicate ITW-type zeolites.

FIG. 17 shows SEM images of (a) synthesized aluminosilicate and (b) pure-silica seed ITW-type zeolites.

FIG. 18 shows the solid-state (a) ²⁹Si and (b) ²⁷Al MAS NMR spectra of the aluminosilicate ITW-type zeolite sample synthesized with 5 wt. % of faujasite crystals

FIG. 19 shows the XRD patterns of the high-silica samples synthesized in fluoride media, from samples 7, 9, and 11 in Table 2.

FIG. 20 shows SEM images of the high-silica samples synthesized in fluoride media, from samples 7, 9, and 11 in Table 2. The scale bars in the figure indicate 10 μm.

FIG. 21 shows the ²⁹Si solid-state MAS NMR spectra of the high-silica samples synthesized in fluoride media, corresponding to samples 7, 9, and 11.

FIG. 22 shows N2 adsorption isotherms of the synthesized aluminosilicate and pure-silica seed ITW-type zeolite.

FIG. 23 shows the solid-state ²⁹Si CP MAS NMR spectrum of the synthesized aluminosilicate ITW-type zeolite.

FIG. 24 shows N2 adsorption isotherms of the synthesized high-silica CHA, *BEA, and STT-type zeolites from Runs 7, 8, 9, 10, 11, and 12.

FIG. 25 shows XRD patterns of the product synthesized with faujasite and Linde type A as aluminum source in the synthesis of STT-type zeolite from Runs 13, 14 and 15.

### DETAILED DESCRIPTION OF THE INVENTION

As used in this specification and the appended claims, the singular forms “a”, “an” and “the” include plural referents unless the context clearly indicates otherwise. Thus, for example, reference to “a catalyst” includes a mixture of two or more catalysts, and the like.

The term “low SAR” means an SAR <2 based on the molar ratio of the corresponding oxides.

The term “intermediate SAR” means an SAR >2 and <5 based on the molar ratio of the corresponding oxides.

The term “high SAR” means an SAR means a SAR >5 based on the molar ratio of the corresponding oxides.

The term “quasi-siliceous seed crystal” means a crystal comprising silica but only trace amounts of alumina, where trace amounts are less than about 100 ppm. The crystal can further comprise germanium, where the ratio of silicon to germanium is between 2.2 and 120.

As used herein the term “zeolite” means a synthetic aluminosilicate molecular sieve having a framework constructed of alumina and silica (i.e., repeating SiO₄ and AlO₄ tetrahedral units). The zeolites of the invention are not silicoaluminophosphates (SAPOs) and thus do not have an appreciable amount of phosphorous in their framework. That is, the zeolite frameworks do not have phosphorous as a regular repeating unit and/or do not have an amount of phosphorous that would affect the basic physical and/or chemical properties of the material, particularly with respect to the material's capacity to selectively reduce NOₓ over a broad temperature range. The amount of framework phosphorous can be less than about 1 weight percent, preferably less than 0.1 weight percent, most preferably less than 0.01 weight percent, based on the total weight of the zeolite.

The term “target zeolite” means the zeolite structure that is attempted to be prepared.

The term “desired framework structure” means the topological type framework structure designated by the International Zeolite Association (IZA) that is trying to be prepared.

The term “pure silica zeolite” means a zeolite having other elements that are present because of their presence as impurities in the materials used to produce the zeolites. These materials are present at low levels, generally tens of ppm or less. For example, a pure zeolite can contain Ge at 50 ppm or less. A pure silica zeolite can have an SAR of greater than 1000 and can contain germanium at a few ppm. Preferably, germanium is not present at detectable levels.

In the first aspect of the invention, a method of producing a high-silica target zeolite having a desired framework structure, the method comprising adding quasi-siliceous seed crystals of a zeolite having the desired framework structure to a fluoride containing gel comprising a structure directing agent (SDA), an alumina source, and a silica source, where the alumina source is a second zeolite having a different framework than the target zeolite and the alumina source become incorporated into the framework of the high-silica target zeolite.

The silica source can be an alkoxide, colloidal silica, silica gel, or fumed silica.

The quasi-siliceous seed crystal can comprise Si, Ge, Al or a combination of two or more thereof. The quasi-siliceous seed crystal can preferable contain germanium. The amount of germanium in the seed crystal, as indicated by the Si/Ge ratio can vary from about 2 to about 200, preferably from about 100 to about 200. In some cases, the Si/Ge ratio can be between 2 and 100 if the stability of the crystal allows it to be used in the synthesis. For example, SiGe-ITQ-29 with a Si/Ge ratio of 2.2 can be used in the synthesis of high SAR LTA.

The quasi-siliceous seed crystal can comprise a framework selected from the group consisting of AEI, AFX, *BEA, CHA, IFY, ITW, LTA and RTH.

The quasi-siliceous seed crystal can comprise a structure directing agent.

The second zeolite can comprise a low or intermediate SAR.

The second zeolite can comprise a framework selected from the group consisting of GME, FAU, MOR and LTA.

The second zeolite can have been ion-exchanged with alkali metal ions, ammonium ions, alkyl ammonium ions or hydrogen ions, preferably ammonium ions.

The amount of the aluminum source can be one or more of about ≦25%, about ≦20%, about ≦15%, about ≦10%, about ≦5%, about ≦2%, about ≦1%, about ≦0.5%, about ≦0.25% or about ≦0.1% by weight of the total amount of silica in the gel. For example, the range of the amount of aluminum source to the silica in the gel can be about 0.1 to 25%, about 0.1 to about 1%, about 1 to about 5%, about 5 to about 25%, about 10 to about 25%, about 1 to about 10%, or about 0.5 to about 5%.

The high-silica target zeolite can have a silica to alumina ratio (SAR) of one or more of about ≧20, about ≧25, about ≧30, about ≧40, about ≧50, about ≧75, about ≧100, about ≧200, about ≧300, about ≧400, about ≧500, about ≧600, about ≧700, about ≧800, about ≧900 and about ≧1000. For example, the target zeolite can have a SAR of about 20 to about 1000, about 20 to about 500, about 500 to about 1000, about 30 to about 50, about 25 to about 45, about 30 to about 45, about 25 to about 35, about 60 to about 100, about 80 to about 100, about 80 to about 120, or about 100 to about 160.

The high-silica target zeolite can have a silica to alumina ratio (SAR) of 20 to infinity, preferably 30 to infinity, wherein “infinity” means that there is no framework Al except as an unintended impurity.

The method of forming a high-silica target zeolite having a desired framework structure can comprise the sequential steps of (a) adding quasi-siliceous seed crystals of a zeolite having the desired framework structure to a reaction mixture comprising a fluoride containing gel comprising a structure directing agent (SDA), an alumina source, and a silica source, where the alumina source is a second zeolite having a different framework than the target zeolite and the alumina source become incorporated into the framework of the high-silica target zeolite and (b) reacting the mixture to form zeolite crystals having an x-ray diffraction pattern consistent with desired topological type. The zeolite crystals formed are preferably separated from the subsequent mother liquor by any conventional technique, such as filtration. Quasi-siliceous seed crystals are added to the reaction mixture to facilitate the nucleation and growth of the desired structure type. Seed crystals can be added in an amount between about 0.1 and about 10% of the weight of silica used in the reaction mixture.

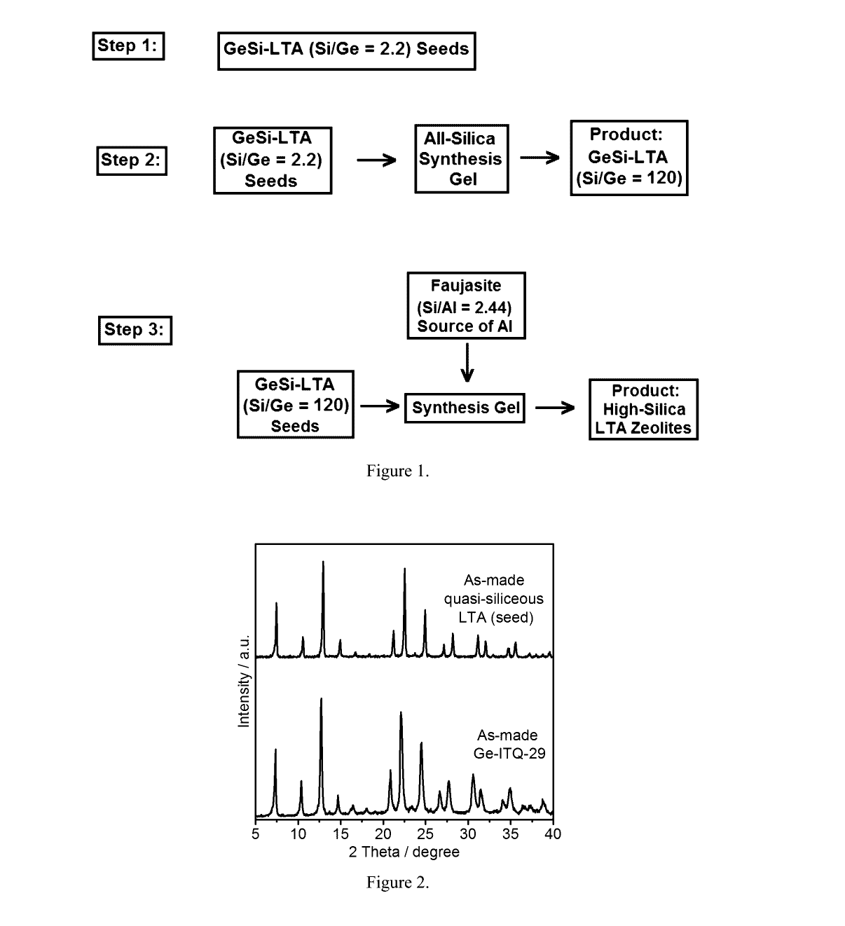

FIG. 1 shows a schematic illustration of a synthesis procedure for the production of high-silica LTA-type zeolites that also shows the formation of LTA-type quasi-siliceous seed crystals having a Si/Ge of 120 from GeSi-ITQ-29 having a Si/Ge of 2.2. Faujasite (Si/Al=2.47) was used as an aluminum source in forming the high-silica LTA-type zeolite, while the LTA-type quasi-siliceous seed crystals were used to aid in the formation of the desired type of zeolite.

The thermochemical stability of both the aluminum source and the seed crystals was an important factor. The aluminosilicate zeolite also has to possess the proper Si/Al ratio.

Faujasite-type zeolites can be used effectively as a source of aluminum to the growing crystals in the synthesis of high-silica LTA-type zeolites because faujasite has a high Al content and is easily dissolved in the reaction medium. Other type zeolites that can be used effectively as a source of aluminum to the growing crystals include GME (large pore, low silica) and LTA (small pore, Si/Al 1-2)

The advantage of using aluminosilicate zeolite crystals as the aluminum source in fluoride media is the high reproducibility and easy control of the Si/Al ratio of the product obtained. The broad applicability of this methodology was demonstrated in the synthesis of several high-silica zeolites in fluoride media. The synthesis of aluminosilicate ITQ-12 (ITW-type zeolite) is reported for the first time. Other aluminosilicate zeolites (CHA-, *BEA-, and STT-type) were also synthesized using this methodology. Aluminum atoms provided from an aluminosilicate zeolite were successfully incorporated in the final framework with tetrahedral coordination. The Si/Al ratio of the final products was controlled by the amount of added aluminosilicate zeolite. All the products obtained had unique features typical of a fluoride mediated synthesis: high Si/Al ratios, large crystal sizes, and almost defect-free structure. These properties are not seen in the products prepared by the conventional synthesis in hydroxide media.

This methodology is also applicable to other zeolite synthesis in fluoride media as shown by the first reported synthesis of an aluminosilicate ITW-type zeolite. ITW-type zeolite has been only known as pure-silica form synthesized in fluoride media (ITQ-12). ITW-type zeolite has 2-dimentional small pore channels, which have shown good hydrocarbon separation properties. Other aluminosilicate zeolites with the CHA-, *BEA-, and STT—framework-type, can be also synthesized in fluoride media while using zeolite crystals as aluminum sources. The zeolite obtained also showed high Si/Al ratios.

In another aspect of the invention, a method of controlling the Si/Al ratio in a high-silica zeolite comprises adding quasi-siliceous seed crystals of a zeolite having the desired framework structure to a fluoride containing gel comprising a structure directing agent (SDA), an alumina source, and a silica source, where the alumina source is a second aluminosilicate zeolite having a different framework than the target zeolite and the alumina source is incorporated into the framework of the high-silica target zeolite.

The Si/Al ratio (SAR) in the high-silica zeolite produced is related to the amount of the second aluminosilicate zeolite added. The addition of a smaller amount of the second zeolite results in the high-silica target zeolite having a higher Si/Al ratio (SAR) compared to when a larger amount of the second aluminosilicate zeolite is added.

The silica source can be an alkoxide, colloidal silica, silica gel, or fumed silica.

The quasi-siliceous seed crystal can comprise Si, Ge, Al or a combination of two or more thereof.

The quasi-siliceous seed crystal can comprise silicon and germanium in a ratio of about 2:1 or greater.

The quasi-siliceous seed crystal can comprise a framework selected from the group consisting of AEI, AFX, *BEA, CHA, IFY, ITW, LTA and RTH.

The quasi-siliceous seed crystal can comprise a structure directing agent.

The second zeolite can comprise a low or intermediate SAR.

The second zeolite can comprise a framework selected from the group consisting of GME, FAU, MOR and LTA.

The second zeolite can have been ion-exchanged with alkali metal ions, ammonium ions, alkyl ammonium ions or hydrogen ions, preferably ammonium ions.

In another aspect of the invention, the method of producing a high-silica target zeolite having a desired framework structure can be used to synthesize zeolites useful as catalysts, sieves to separate molecules of certain dimensions, adsorption or ion-exchange materials.

Zeolites, as used herein, are free or substantially free of framework atoms or T-atoms, other than silicon and aluminum. Thus, a “zeolite” is distinct from a “metal-substituted zeolite”, wherein the latter comprises a framework that contains one or more non-aluminum metals substituted into the zeolite's framework. The zeolite framework, or the zeolite as a whole, can be free or essentially free of transition metals, including copper, nickel, zinc, iron, tungsten, molybdenum, cobalt, titanium, zirconium, manganese, chromium, vanadium, niobium, as well as tin, bismuth, and antimony; is free or essentially free of noble metals including platinum group metals (PGMs), such as ruthenium, rhodium, palladium, indium, platinum, and precious metals such as gold and silver; and is free or essentially free of rare earth metals such as lanthanum, cerium, praseodymium, neodymium, europium, terbium, erbium, ytterbium, and yttrium. The high SAR zeolite of the invention may contain low levels of iron: the iron may in a framework tetrahedral site and/or as a cationic (extra-framework) species. The amount of iron in a framework tetrahedral site and/or as a cationic species following synthesis is usually less than about 0.1 weight percent.

Small impurities of alkali and alkali-earth may be present, but are not needed for synthesis to occur.

Preferably, the overall process will have an overall yield on silica of at least about 60%. Preferably, the overall process will have an overall yield on SDA of at least about 40%, preferably at least about 60%, more preferably at least about 80%, even more preferably at least about 90%, most preferably at least about 95%.

Suitable silica sources include, without limitation, fumed silica, silicates, precipitated silica, colloidal silica, silica gels, zeolites such as zeolite Y and/or zeolite X, and silicon hydroxides and alkoxides. Silica sources resulting in a high relative yield are preferred. Alumina sources are zeolites such as FAU, GME, LTA or MOR. Typically, a source of fluoride ions, such as NH4F, NH4HF2 or HF, is used in the reaction mixture.

The reaction mixture can be in the form of a solution, a colloidal dispersion (colloidal sol), gel, or paste, with a gel being preferred. High SAR zeolites can be prepared from a reaction mixture having the composition shown in Table 1. Silicon- and aluminum-containing reactants are expressed as SiO₂ and Al₂O₃, respectively.

TABLE 1

| | Typical | Preferred |
|---|---|---|
| SiO₂/Al₂O₃ | 10-100 | 15-60 |
| F⁻/SiO₂ | 0.5-1.0 | 0.6-0.8 |
| SDA/SiO₂ | 0.05-0.50 | 0.10-0.25 |
| H₂O/SiO₂ | 2-80 | 4-10 |

Reaction temperatures, mixing times and speeds, and other process parameters that are suitable for fluoride containing synthesis techniques are also generally suitable for the present invention. Generally, the reaction mixture is maintained at an elevated temperature until the targeted zeolite crystals are formed. The hydrothermal crystallization is usually conducted under autogenous pressure, at a temperature between about 75-220° C., for example between about 120 and 160° C., for duration of several hours, for example, about 0.1-20 days, and preferably from about 0.5-3 days. Preferably, the zeolite is prepared using stirring or agitation.

Once the zeolite crystals have formed, the solid product is separated from the reaction mixture by standard separation techniques such as filtration. The crystals are water-washed and then dried, for several seconds to a few minutes (e.g., 5 second to 10 minutes for flash drying) or several hours (e.g., about 4-24 hours for oven drying at 75-150° C.), to obtain the as-synthesized high SAR zeolite crystals. The drying step can be performed at atmospheric pressure or under vacuum.

It will be appreciated that the foregoing sequence of steps, as well as each of the above-mentioned periods of time and temperature values are merely exemplary and may be varied.

The high SAR zeolite crystals produced in accordance with this process can be uniform, with little to no twinning and/or multiple twinning or may form agglomerates.

The high SAR zeolite crystals produced in accordance with the methods described herein have a mean crystalline size of about 0.01 to about 5 for example about 0.5 to about 5 about 0.1 to about 5 μm, about 1 to about 5 and about 0.5 to about 5 μm. Large crystals can be milled using a jet mill or other particle-on-particle milling technique to an average size of about 1.0 to about 1.5 micron to facilitate washcoating a slurry containing the catalyst to a substrate, such as a flow-through monolith.

High SAR zeolite synthesized by the methods described herein preferably have a silica-to-alumina ratio (SAR) of at least about 8, for example about 8 to about 100, about 10 to about 50, or about 15 to about 25. The silica-to-alumina ratio of zeolites may be determined by conventional chemical analysis. This ratio is meant to represent, as closely as possible, the ratio in the rigid atomic framework of the zeolite crystal and to exclude silicon or aluminum in the binder (for catalyst applications) or, in cationic or other form, within the channels.

The high SAR zeolite is useful as a catalyst in certain applications. Organic molecules located within the structure must be removed to form the micropores and allow access to the active sites within the zeolite structure. The catalyst containing a high SAR zeolite can also be used either without a post-synthesis metal exchange or with a post-synthesis metal exchange. Thus, in certain aspects of the invention, provided is a catalyst comprising a high SAR zeolite, wherein the high SAR zeolite is free or essentially free of any exchanged metal, particularly post-synthesis exchanged or impregnated metals. A catalyst can comprise a high SAR zeolite containing one or more catalytic metal ions exchanged or otherwise impregnated into the channels and/or cavities of the zeolite. Examples of metals that can be post-zeolite synthesis exchanged or impregnated include transition metals, including copper, nickel, zinc, iron, tungsten, molybdenum, cobalt, titanium, zirconium, manganese, chromium, vanadium, niobium, as well as tin, bismuth, and antimony; noble metals including platinum group metals (PGMs), such as ruthenium, rhodium, palladium, indium, platinum, and precious metals such as gold and silver; alkaline earth metals such as beryllium, magnesium, calcium, strontium, and barium; and rare earth metals such as lanthanum, cerium, praseodymium, neodymium, europium, terbium, erbium, ytterbium, and yttrium. Preferred transition metals for post-synthesis exchange are base metals, and preferred base metals include those selected from the group consisting of manganese, iron, cobalt, nickel, copper and mixtures thereof.

The transition metal can be present in an amount of about 0.1 to about 10 weight percent, for example about 0.5 to about 5 weigh percent, about 0.1 to about 1.0 weight percent, about 2.5 to about 3.5 weight percent, and about 4.5 to about 5.5 weight percent, wherein the weight percent is relative to the total weight of the zeolite material.

Particularly preferred exchanged metals include copper and iron, particularly when combined with calcium and/or cerium and particularly when the transition metals (TM) and the alkaline metals (AM) can be present in a T_{M}:A_{M} molar ratio of about 15:1 to about 1:1, for example about 10:1 to about 2:1, about 10:1 to about 3:1, or about 6:1 to about 4:1.

Metals incorporated post-synthesis can be added to the molecular sieve via any known technique such as ion exchange, impregnation, isomorphous substitution, etc.

These exchanged metal cations are distinct from metals constituting the molecular framework of the zeolite, and thus metal exchanged zeolites are distinct from metal-substituted zeolites.

Where the catalyst is part of a washcoat composition, the washcoat may further comprise a binder containing Ce or ceria. When the binder contains Ce or ceria, the Ce containing particles in the binder are significantly larger than the Ce containing particles in the catalyst.

Catalysts of the invention are particularly applicable for heterogeneous catalytic reaction systems (i.e., solid catalyst in contact with a gas reactant). To improve contact surface area, mechanical stability, and/or fluid flow characteristics, the catalysts can be disposed on and/or within a substrate, preferably a porous substrate. A washcoat containing the catalyst can be applied to an inert substrate, such as corrugated metal plate or a honeycomb cordierite brick. Alternatively, the catalyst is kneaded along with other components such as fillers, binders, and reinforcing agents, into an extrudable paste which is then extruded through a die to form a honeycomb brick. Accordingly, a catalyst article can comprise a high SAR zeolite catalyst described herein coated on and/or incorporated into a substrate.

Certain aspects of the invention provide a catalytic washcoat. The washcoat comprising a high SAR zeolite catalyst described herein is preferably a solution, suspension, or slurry. Suitable coatings include surface coatings, coatings that penetrate a portion of the substrate, coatings that permeate the substrate, or some combination thereof.

A washcoat can also include non-catalytic components, such as fillers, binders, stabilizers, rheology modifiers, and other additives, including one or more of alumina, silica, non-zeolite silica alumina, titania, zirconia, ceria. The catalyst composition can comprise pore-forming agents such as graphite, cellulose, starch, polyacrylate, and polyethylene, and the like. These additional components do not necessarily catalyze the desired reaction, but instead improve the catalytic material's effectiveness, for example, by increasing its operating temperature range, increasing contact surface area of the catalyst, increasing adherence of the catalyst to a substrate, etc. Preferably, the washcoat loading is >0.3 g/in³, such as >1.2 g/in³, >1.5 g/in³, >1.7 g/in³ or >2.00 g/in³, and preferably <3.5 g/in³, such as <2.5 g/in³. The washcoat can be applied to a substrate in a loading of about 0.8 to 1.0 g/in³, 1.0 to 1.5 g/in³, or 1.5 to 2.5 g/in³.

Two of the most common substrate designs to which catalyst may be applied are plate and honeycomb. Preferred substrates, particularly for mobile applications, include flow-through monoliths having a so-called honeycomb geometry that comprise multiple adjacent, parallel channels that are open on both ends and generally extend from the inlet face to the outlet face of the substrate and result in a high-surface area-to-volume ratio. For certain applications, the honeycomb flow-through monolith preferably has a high cell density, for example about 600 to 800 cells per square inch, and/or an average internal wall thickness of about 0.18-0.35 mm, preferably about 0.20-0.25 mm. For certain other applications, the honeycomb flow-through monolith preferably has a low cell density of about 150-600 cells per square inch, more preferably about 200-400 cells per square inch. Preferably, the honeycomb monoliths are porous. In addition to cordierite, silicon carbide, silicon nitride, ceramic, and metal, other materials that can be used for the substrate include aluminum nitride, silicon nitride, aluminum titanate, a-alumina, mullite, e.g., acicular mullite, pollucite, a thermet such as Al₂OsZFe, Al₂O₃/Ni or B₄CZFe, or composites comprising segments of any two or more thereof. Preferred materials include cordierite, silicon carbide, and alumina titanate.

Plate-type catalysts have lower pressure drops and are less susceptible to plugging and fouling than the honeycomb types, which is advantageous in high efficiency stationary applications, but plate configurations can be much larger and more expensive. A honeycomb configuration is typically smaller than a plate type, which is an advantage in mobile applications, but has higher pressure drops and plug more easily. The plate substrate can be constructed of metal, preferably corrugated metal.

In one aspect of the invention, a catalyst article is made by a process described herein. The catalyst article can be produced by a process that includes the steps of applying a high SAR zeolite catalyst composition, preferably as a washcoat, to a substrate as a layer either before or after at least one additional layer of another composition for treating exhaust gas has been applied to the substrate. The one or more catalyst layers on the substrate, including the high SAR zeolite catalyst layer, are arranged in consecutive layers. As used herein, the term “consecutive” with respect to catalyst layers on a substrate means that each layer is contact with its adjacent layer(s) and that the catalyst layers as a whole are arranged one on top of another on the substrate.

The high SAR zeolite catalyst can be disposed on the substrate as a first layer or zone and another composition, such as an oxidation catalyst, reduction catalyst, scavenging component, or NOₓ storage component, can be disposed on the substrate as a second layer or zone. As used herein, the terms “first layer” and “second layer” are used to describe the relative positions of catalyst layers in the catalyst article with respect to the normal direction of exhaust gas flow-through, past, and/or over the catalyst article. Under normal exhaust gas flow conditions, exhaust gas contacts the first layer prior to contacting the second layer. The second layer can be applied to an inert substrate as a bottom layer and the first layer is a top layer that is applied over the second layer as a consecutive series of sub-layers.

The exhaust gas can penetrate (and hence contact) the first layer, before contacting the second layer, and subsequently returns through the first layer to exit the catalyst component.

The first layer can be a first zone disposed on an upstream portion of the substrate and the second layer is disposed on the substrate as a second zone, wherein the second zone is downstream of the first.

The catalyst article can be produced by a process that includes the steps of applying a high SAR zeolite catalyst composition, preferably as a washcoat, to a substrate as a first zone, and subsequently applying at least one additional composition for treating an exhaust gas to the substrate as a second zone, wherein at least a portion of the first zone is downstream of the second zone. Alternatively, the high SAR zeolite catalyst composition can be applied to the substrate in a second zone that is downstream of a first zone containing the additional composition. Examples of additional compositions include oxidation catalysts, reduction catalysts, scavenging components (e.g., for sulfur, water, etc.), or NOₓ storage components.

To reduce the amount of space required for an exhaust system, individual exhaust components can be designed to perform more than one function. For example, applying an SCR catalyst to a wall-flow filter substrate instead of a flow-through substrate serves to reduce the overall size of an exhaust treatment system by allowing one substrate to serve two functions, namely catalytically reducing NOₓ concentration in the exhaust gas and mechanically removing soot from the exhaust gas. The substrate can be a honeycomb wall-flow filter or partial filter. Wall-flow filters are similar to flow-through honeycomb substrates in that they contain a plurality of adjacent, parallel channels. However, the channels of flow-through honeycomb substrates are open at both ends, whereas the channels of wall-flow substrates have one end capped, wherein the capping occurs on opposite ends of adjacent channels in an alternating pattern. Capping alternating ends of channels prevents the gas entering the inlet face of the substrate from flowing straight through the channel and existing. Instead, the exhaust gas enters the front of the substrate and travels into about half of the channels where it is forced through the channel walls prior to entering the second half of the channels and exiting the back face of the substrate.

The substrate wall has a porosity and pore size that is gas permeable, but traps a major portion of the particulate matter, such as soot, from the gas as the gas passes through the wall. Preferred wall-flow substrates are high efficiency filters. Wall flow filters for use with the invention preferably have an efficiency of least 70%, at least about 75%, at least about 80%, or at least about 90%. The efficiency can be from about 75 to about 99%, about 75 to about 90%, about 80 to about 90%, or about 85 to about 95%. Here, efficiency is relative to soot and other similarly sized particles and to particulate concentrations typically found in conventional diesel exhaust gas. For example, particulates in diesel exhaust can range in size from about 0.05 microns to about 2.5 microns. Thus, the efficiency can be based on this range or a sub-range, such as about 0.1 to about 0.25 microns, about 0.25 to about 1.25 microns, or about 1.25 to about 2.5 microns.

Porosity is a measure of the percentage of void space in a porous substrate and is related to backpressure in an exhaust system: generally, the lower the porosity, the higher the backpressure. Preferably, the porous substrate has a porosity of about 30 to about 80%, for example about 40 to about 75%, about 40 to about 65%, or from about 50 to about 60%.

The pore interconnectivity, measured as a percentage of the substrate's total void volume, is the degree to which pores, void, and/or channels, are joined to form continuous paths through a porous substrate, i.e., from the inlet face to the outlet face. In contrast to pore interconnectivity is the sum of closed pore volume and the volume of pores that have a conduit to only one of the surfaces of the substrate. Preferably, the porous substrate has a pore interconnectivity volume of at least about 30%, more preferably at least about 40%.

The mean pore size of the porous substrate is also important for filtration. Mean pore size can be determined by any acceptable means, including by mercury porosimetry. The mean pore size of the porous substrate should be of a high enough value to promote low backpressure, while providing an adequate efficiency by either the substrate per se, by promotion of a soot cake layer on the surface of the substrate, or combination of both. Preferred porous substrates have a mean pore size of about 10 to about 40 μm, for example about 20 to about 30 μm, about 10 to about 25 μm, about 10 to about 20 μm, about 20 to about 25 μm, about 10 to about 15 μm, and about 15 to about 20 μm.

In general, the production of an extruded solid body, such as honeycomb flow-through or wall-flow filter, containing a high SAR zeolite catalyst involves blending the high SAR zeolite catalyst, a binder, an optional organic viscosity-enhancing compound into an homogeneous paste which is then added to a binder/matrix component or a precursor thereof and optionally one or more of stabilized ceria, and inorganic fibers. The blend is compacted in a mixing or kneading apparatus or an extruder. The mixtures have organic additives such as binders, pore formers, plasticizers, surfactants, lubricants, dispersants as processing aids to enhance wetting and therefore produce a uniform batch. The resulting plastic material is then molded, in particular using an extrusion press or an extruder including an extrusion die, and the resulting moldings are dried and calcined. The organic additives are “burnt out” during calcinations of the extruded solid body. A high SAR zeolite catalyst may also be washcoated or otherwise applied to the extruded solid body as one or more sub-layers that reside on the surface or penetrate wholly or partly into the extruded solid body.

The binder/matrix component is preferably selected from the group consisting of cordierite, nitrides, carbides, borides, intermetallics, lithium aluminosilicate, a spinel, an optionally doped alumina, a silica source, titania, zirconia, titania-zirconia, zircon and mixtures of any two or more thereof. The paste can optionally contain reinforcing inorganic fibers selected from the group consisting of carbon fibers, glass fibers, metal fibers, boron fibers, alumina fibers, silica fibers, silica-alumina fibers, silicon carbide fibers, potassium titanate fibers, aluminum borate fibers and ceramic fibers.

The alumina binder/matrix component is preferably gamma alumina, but can be any other transition alumina, i.e., alpha alumina, beta alumina, chi alumina, eta alumina, rho alumina, kappa alumina, theta alumina, delta alumina, lanthanum beta alumina and mixtures of any two or more such transition aluminas. It is preferred that the alumina is doped with at least one non-aluminum element to increase the thermal stability of the alumina. Suitable alumina dopants include silicon, zirconium, barium, lanthanides and mixtures of any two or more thereof. Suitable lanthanide dopants include La, Ce, Nd, Pr, Gd and mixtures of any two or more thereof.

Preferably, the high SAR zeolite catalyst is dispersed throughout, and preferably evenly throughout, the entire extruded catalyst body.

Where any of the above-extruded solid bodies are made into a wall-flow filter, the porosity of the wall-flow filter can be from 30-80%, such as from 40-70%. Porosity and pore volume and pore radius can be measured e.g. using mercury intrusion porosimetry.

The high SAR zeolite catalyst described herein can promote the reaction of a reductant, preferably ammonia, with nitrogen oxides to selectively form elemental nitrogen (N₂) and water (H₂O). Thus, the catalyst can be formulated to favor the reduction of nitrogen oxides with a reductant (i.e., an SCR catalyst). Examples of such reductants include hydrocarbons (e.g., C3-C6 hydrocarbons) and nitrogenous reductants such as ammonia and ammonia hydrazine or any suitable ammonia precursor, such as urea ((NH₂)₂CO), ammonium carbonate, ammonium carbamate, ammonium hydrogen carbonate or ammonium formate.

The high SAR zeolite catalyst described herein can also promote the oxidation of ammonia. The catalyst can be formulated to favor the oxidation of ammonia with oxygen, particularly a concentrations of ammonia typically encountered downstream of an SCR catalyst (e.g., ammonia oxidation (AMOX) catalyst, such as an ammonia slip catalyst (ASC)). The high SAR zeolite catalyst can be disposed as a top layer over an oxidative under-layer, wherein the under-layer comprises a platinum group metal (PGM) catalyst or a non-PGM catalyst. Preferably, the catalyst component in the underlayer is disposed on a high surface area support, including but not limited to alumina.

SCR and AMOX operations can be performed in series, wherein both processes utilize a catalyst comprising a high SAR zeolite described herein, and wherein the SCR process occurs upstream of the AMOX process. For example, an SCR formulation of the catalyst can be disposed on the inlet side of a filter and an AMOX formulation of the catalyst can be disposed on the outlet side of the filter.

Also provided is a method for the reduction of NOₓ compounds or oxidation of NH₃ in a gas, which comprises contacting the gas with a catalyst composition comprising a high SAR zeolite described herein for the catalytic reduction of NOₓ compounds for a time sufficient to reduce the level of NOₓ compounds and/or NH₃ in the gas. A catalyst article can have an ammonia slip catalyst disposed downstream of a selective catalytic reduction (SCR) catalyst. The ammonia slip catalyst can oxidize at least a portion of any nitrogenous reductant that is not consumed by the selective catalytic reduction process. The ammonia slip catalyst can be disposed on the outlet side of a wall flow filter and an SCR catalyst can be disposed on the upstream side of a filter. The ammonia slip catalyst can be disposed on the downstream end of a flow-through substrate and an SCR catalyst can be disposed on the upstream end of the flow-through substrate. The ammonia slip catalyst and SCR catalyst can be disposed on separate bricks within the exhaust system. These separate bricks can be adjacent to, and in contact with, each other or separated by a specific distance, provided that they are in fluid communication with each other and provided that the SCR catalyst brick is disposed upstream of the ammonia slip catalyst brick.

The SCR and/or AMOX process can be performed at a temperature of at least 100° C.

These process(es) can occur at a temperature from about 150° C. to about 750° C., inclusive, preferably from about 175 to about 550° C., inclusive, more preferably from 175 to 400° C., inclusive.

These process(es) can occur at a temperature from about 450 to about 900° C., inclusive, preferably from about 500° C. to about 750° C., inclusive, more preferably from about 500° C. to about 650° C., inclusive.

The process can also occur at about 450° C. to 550° C., inclusive, or about 650° C. to about 850 C, inclusive.

Temperatures greater than 450° C. are particularly useful for treating exhaust gases from a heavy and light duty diesel engine that is equipped with an exhaust system comprising (optionally catalyzed) diesel particulate filters which are regenerated actively, e.g. by injecting hydrocarbon into the exhaust system upstream of the filter, wherein the high SAR zeolite catalyst of the invention is located downstream of the filter.

According to another aspect of the invention, provided is a method for the reduction of NOx compounds and/or oxidation of NH₃ in a gas, which comprises contacting the gas with a catalyst described herein for a time sufficient to reduce the level of NOₓ compounds in the gas. Methods of the invention may comprise one or more of the following steps: (a) accumulating and/or combusting soot that is in contact with the inlet of a catalytic filter; (b) introducing a nitrogenous reducing agent into the exhaust gas stream prior to contacting the catalytic filter, preferably with no intervening catalytic steps involving the treatment of NOₓ and the reductant; (c) generating NH₃ over a NOₓ adsorber catalyst or lean NOₓ trap, and preferably using such NH₃ as a reductant in a downstream SCR reaction; (d) contacting the exhaust gas stream with a DOC to oxidize hydrocarbon based soluble organic fraction (SOF) and/or carbon monoxide into CO₂, and/or oxidize NO into NO₂, which in turn, may be used to oxidize particulate matter in particulate filter; and/or reduce the particulate matter (PM) in the exhaust gas; (e) contacting the exhaust gas with one or more flow-through SCR catalyst device(s) in the presence of a reducing agent to reduce the NOx concentration in the exhaust gas; and (f) contacting the exhaust gas with an ammonia slip catalyst, preferably downstream of the SCR catalyst to oxidize most, if not all, of the ammonia prior to emitting the exhaust gas into the atmosphere or passing the exhaust gas through a recirculation loop prior to exhaust gas entering/re-entering the engine.

All or at least a portion of the nitrogen-based reductant, particularly NH₃, for consumption in the SCR process can be supplied by a NOx adsorber catalyst (NAC), a lean NOx trap (LNT), or a NOx storage/reduction catalyst (NSRC), disposed upstream of the SCR catalyst, e.g., a SCR catalyst of the invention disposed on a wall-flow filter. NAC components useful in the invention include a catalyst combination of a basic material (such as alkali metal, alkaline earth metal or a rare earth metal, including oxides of alkali metals, oxides of alkaline earth metals, and combinations thereof), and a precious metal (such as platinum), and optionally a reduction catalyst component, such as rhodium. Specific types of basic material useful in the NAC include cesium oxide, potassium oxide, magnesium oxide, sodium oxide, calcium oxide, strontium oxide, barium oxide, and combinations thereof. The precious metal is preferably present at about 10 to about 200 g/ft³, such as 20 to 60 g/ft³. Alternatively, the precious metal of the catalyst is characterized by the average concentration which may be from about 40 to about 100 grams/ft³.

Under certain conditions, during the periodically rich regeneration events, NH₃ may be generated over a NOₓ adsorber catalyst. The SCR catalyst downstream of the NOₓ adsorber catalyst may improve the overall system NOₓ reduction efficiency. In the combined system, the SCR catalyst is capable of storing the released NH₃ from the NAC catalyst during rich regeneration events and utilizes the stored NH₃ to selectively reduce some or all of the NOₓ that slips through the NAC catalyst during the normal lean operation conditions.

The method for treating exhaust gas as described herein can be performed on an exhaust gas derived from a combustion process, such as from an internal combustion engine (whether mobile or stationary), a gas turbine and coal or oil fired power plants. The method may also be used to treat gas from industrial processes such as refining, from refinery heaters and boilers, furnaces, the chemical processing industry, coke ovens, municipal waste plants and incinerators, etc. The method can be used for treating exhaust gas from a vehicular lean burn internal combustion engine, such as a diesel engine, a lean-burn gasoline engine or an engine powered by liquid petroleum gas or natural gas.

In certain aspects, the invention is a system for treating exhaust gas generated by combustion process, such as from an internal combustion engine (whether mobile or stationary), a gas turbine, coal or oil fired power plants, and the like. Such systems include a catalytic article comprising the high SAR zeolite catalysts described herein and at least one additional component for treating the exhaust gas, wherein the catalytic article and at least one additional component are designed to function as a coherent unit.

A system can comprise a catalytic article comprising a high SAR zeolite catalyst described herein, a conduit for directing a flowing exhaust gas, a source of nitrogenous reductant disposed upstream of the catalytic article. The system can include a controller for the metering the nitrogenous reductant into the flowing exhaust gas only when it is determined that the zeolite catalyst is capable of catalyzing NOₓ reduction at or above a desired efficiency, such as at above 100° C., above 150° C. or above 175° C. The metering of the nitrogenous reductant can be arranged such that 60% to 200% of theoretical ammonia is present in exhaust gas entering the SCR catalyst calculated at 1:1 NH₃/NO and 4:3 NH₃/NO₂.

The system comprises an oxidation catalyst (e.g., a diesel oxidation catalyst (DOC)) for oxidizing nitrogen monoxide in the exhaust gas to nitrogen dioxide can be located upstream of a point of metering the nitrogenous reductant into the exhaust gas. The oxidation catalyst can be adapted to yield a gas stream entering the SCR zeolite catalyst having a ratio of NO to NO₂ of from about 4:1 to about 1:3 by volume, e.g. at an exhaust gas temperature at oxidation catalyst inlet of 250° C. to 450° C. The oxidation catalyst can include at least one platinum group metal (or some combination of these), such as platinum, palladium, or rhodium, coated on a flow-through monolith substrate. The at least one platinum group metal can be platinum, palladium or a combination of both platinum and palladium. The platinum group metal can be supported on a high surface area washcoat component such as alumina, a zeolite such as an aluminosilicate zeolite, silica, non-zeolite silica alumina, ceria, zirconia, titania or a mixed or composite oxide containing both ceria and zirconia.

A suitable filter substrate is located between the oxidation catalyst and the SCR catalyst. Filter substrates can be selected from any of those mentioned above, e.g. wall flow filters. Where the filter is catalyzed, e.g. with an oxidation catalyst of the kind discussed above, preferably the point of metering nitrogenous reductant is located between the filter and the zeolite catalyst. Alternatively, if the filter is un-catalyzed, the means for metering nitrogenous reductant can be located between the oxidation catalyst and the filter.

The high SAR zeolite catalysts described herein can be used in reducing emissions in the exhaust gas of combustion engines, in hydrocarbon conversion reactions, such as isomerizations, aromatizations, and alkylations, and cracking reactions

### EXAMPLES

Materials produced in the examples described below were characterized by one or more of the following analytic methods. Powder X-ray diffraction (PXRD) patterns were collected on a X'pert powder diffactometer (Philips) using a CuKα radiation (45 kV, 40 mA) at a step size of 0.04° and a 1 s per step between 5° and 40° (2θ). For the unit cell parameters refinement, the samples were mixed with a silicon standard (10-20 wt. %) to correct the peak positions; XRD patterns were collected using a step size of 0.01° and a count time of 3 s per step between 25° and 35° (2θ). Celref software was used to refine the unit cell parameters of high-silica LTA-type zeolite samples. The unit cell refinement was carried out using six peaks observed in 2 theta from 25° to 35° in the space group Pm3m. Scanning electron microscopy (SEM) images and chemical compositions by energy-dispersive X-ray spectroscopy (EDX) were obtained on a JSM7400F microscope (JEOL) with an accelerating voltage of 3-10 KeV. The micropore volume and surface area were measured using N₂ at 77 K on a 3Flex surface characterization analyzer (Micrometrics). Solid-state NMR spectra were collected on an Avance III spectrometer (Bruker). UV-vis spectra were collected on a V-550 spectrometer (Jasco) with a diffuse reflectance cell attachment using BaSO₄ as a reference. Elemental analyses were conducted using inductively coupled plasma atomic emission spectroscopy (ICP-AES) by Galbraith Laboratories, Tennessee.

### Example 1

### Synthesis of the Organic SDA for producing an LTA-Type Zeolite

4-Methyl-2,3,6,7-tetrahydro-1H,5H-pyrido[3.2.1-ij] quinolinium (methylated-julolidine) hydroxide was used as the SDA for the synthesis of seed crystals and high-silica LTA-type zeolites. The synthesis procedure was described previously. Typically, 10 g of julolidine was dissolved in 100 ml of chloroform. 23 g of methyl iodide was added to the solution, and the reaction mixture was stirred at room temperature for 3 days. Then, another 23 g of methyl iodide was added to the solution, and the solution was stirred for 3 more days at room temperature. The same procedure (adding the same amount of methyl iodide and stirring at room temperature for 3 days) was repeated one more time, resulting in the total reaction time for 9 days. A solid was obtained by slowly adding diethyl ether (˜200 ml) into the solution. The dark orange solid precipitate was filtered and dried in air. Purification was carried out by dissolving the solid product into 100 ml of chloroform again, and precipitating by the addition of 200 ml of diethyl ether. The purification process was repeated 3 times and the final product was dried at room temperature. Before being used in zeolite synthesis, the iodide form of the organic SDA was ion-exchanged to the hydroxide form with ion-exchange resin (A-26(OH), Amberlyst). Prior to the addition of the resin, the organic SDA was dissolved in water for 1 hour because its solubility is low. About 5 g of resin were used for 80 g of SDA iodide solution (0.08 M). The ion-exchange step was carried out for 12 h at room temperature, and this step was repeated three times. This resulted in over 90% conversion of the iodide form to the hydroxide form. The solution was concentrated to 0.15-0.2 M using a rotary evaporator and titrated with hydrochloric acid to measure the OH⁻ concentration.

### Example 2

### Synthesis of the Organic SDA for ITW-Type Zeolite

1,2,3-trimethyl imidasolium hydroxide was used as the organic SDA for the synthesis of seed crystals and high-silica ITW-type zeolites. The synthesis procedure was described previously. Typically, 8 g of 1,2-dimethyl imidazole was dissolved in 100 ml of chloroform. 30 g of methyl iodide was added to the solution, and the reaction mixture was stirred at room temperature for 2 days. A white-orange solid precipitate was filtered, washed with chloroform, and dried at room temperature. Before being used in zeolite synthesis, the iodide form of the organic SDA was ion-exchanged to the hydroxide form with ion-exchange resin. About 5 g of resin were used for 50 g of SDA iodide solution (0.2 M). The ion-exchange step was carried out for 1 day at room temperature, and this step was repeated three times. This resulted in about a 70% conversion of the iodide form to the hydroxide form. It was not possible to increase the level of ion exchange above this value. The solution was concentrated to 0.15-0.2 M by rotary evaporator and titrated with hydrochloric acid to measure the OW concentration.

### Example 3

### Synthesis of the Quasi-Siliceous LTA-Type Seed Crystals

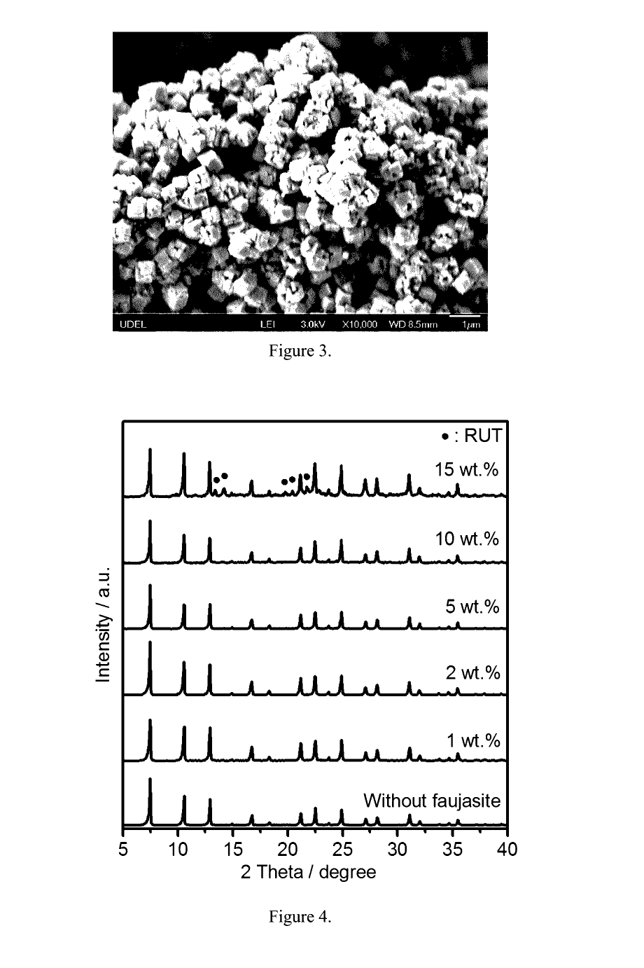

Quasi-siliceous seed crystals (Si/Ge=120) were synthesized by adding about 5 wt. % of the total amount of silica formed from TEOS of germanosilicate ITQ-29 crystals into the reaction mixture in the synthesis procedure of pure-silica ITQ-29. Germanosilicate ITQ-29 was synthesized by the hydrothermal reaction of a condensed reaction gel as described in a previous report. The XRD pattern of the as-made Ge-ITQ-29 is shown in FIG. 2. In the synthesis of quasi-siliceous seed crystals, tetraethylorthosilicate (TEOS) was hydrolyzed in a solution containing a mixture of methylated-julolidine hydroxide (ROH) and tetramethylammonium hydroxide (TMAOH, 25% aqueous solution, Alfa Aesar) under stirring at room temperature for 3 hours. After the solution became homogeneous, as-made germanosilicate ITQ-29 (5 wt. % of the total silica formed from TEOS) was added to the solution and stirred for 1 h. Hydrofluoric acid (HF, 48-51% aqueous solution) was then added to the mixture, and the resulting gel was stirred by hand with a spatula. The homogenized gel (in an open container) was placed in an oven at 353 K to adjust the water to silica ratio (H20/Si02) of 2. The final chemical composition was 1SiO₂/0.25ROH/0.25TMAOH/0.5HF/2H₂O and 5 wt. % of seed crystals. The final synthesis gel was transferred into a 23 mL Teflon-lined autoclave and subjected to a hydrothermal treatment at 408 K for 2 days under rotation (40-60 rpm). The samples were filtered and washed with DI water, and dried in an oven at 353 K. In the final step, the samples were calcined to remove the occluded organic SDAs at 823 K for 5 h with ramping rate of 2 K/min. The XRD pattern and an SEM image of the quasi-siliceous seed crystals are shown in FIGS. 2 and 3. In FIG. 3, the scale bar indicates 1 p.m. The seed crystals had a highly crystalline LTA-type framework and cubic morphology with 500 to 800 nm in size.

### Example 4

### Synthesis of High-Silica LTA-Type Zeolites

High-silica LTA-type zeolites were synthesized by the addition of small amounts of as-made quasi-siliceous seed crystals and as-received NH₄-form faujasite crystals (Si/Al=2.47, CBV500, Zeolyst) to the synthesis gel of pure-silica ITQ-29.^{Error! Reference source not found.} FIG. 1 illustrates the synthesis protocol. Tetraethylorthosilicate (TEOS, Aldrich) was hydrolyzed in an aqueous solution containing both methylated-julolidine hydroxide (ROH) and tetramethylammonium hydroxide (TMAOH, 25% aqueous solution, Alfa Aesar) under stirring at room temperature for 3 hours. After the solution became homogeneous, the required amount of faujasite crystals (0 to 15 wt. % of the total silica formed from TEOS) together with the quasi-siliceous seed crystals (5 wt. % of the total silica formed from TEOS) was added to the solution and stirred for 1 h. Then hydrofluoric acid (HF, 48-51% aqueous solution, Acros) was added to the mixture, and the resulting gel was stirred by hand with a spatula. The homogenized gel (in an open container) was placed in an oven at 353 K to adjust the water to silica ratio (H₂O/SiO₂) of 2. The final chemical composition was 1SiO₂/0.25ROH/0.25TMAOH/0.5HF/2H₂O plus the required amount of faujasite crystals and 5 wt. % of seed crystals. If the reaction gel was not homogeneous at this stage, the gel was mixed by hand again before transferring into the autoclave. The final synthesis gel was orange in color (to the naked eye) as a result of the concentrated SDA. The gel was transferred into a 23 mL Teflon-lined autoclave (#4749, Parr), and subjected to a hydrothermal treatment at 408 K for 5 days under rotation. The samples were then filtered, washed with DI water, and dried in air in an oven at 353 K. Prior to characterization, the samples were calcined in air to remove the occluded organic SDAs at 823 K for 5 hours with ramping rate of 2 K/min. A list of the samples synthesized is summarized in Table 2.

High-silica LTA-type zeolites were synthesized by the addition of small amounts of as-made quasi-siliceous seed crystals and as-received ammonium faujasite crystals (Si/Al=2.47) to the synthesis gel of pure-silica ITQ-29. The gel was prepared as described above except for the addition of the required amount of faujasite crystals (0 to 15 wt. % of the total silica formed from TEOS) together with the nearly-siliceous seed crystals (5 wt. % of the total silica formed from TEOS). The faujasite crystals were added as-received in the NH₄-form to avoid contamination by alkaline cations, and to keep the thermochemical stability low for ease of dissolution. The quasi-siliceous seed crystals were also added without calcination because it was expected that the organic SDAs would stabilize the framework towards dissolution. A homogeneous reaction gel was prepared by adding the faujasite and seed crystals to a gel containing an organic SDA before the gel became very thick by the addition of hydrofluoric acid. Both the final reaction gels and the obtained products were orange in color (to the naked eye) as a result of the concentrated SDA.

The Si/Al ratio of the reaction gel was estimated based on the amount of faujasite crystals added. Addition of 1, 2, 5, 10, and 15 wt. % of faujasite crystals resulted in gel Si/Al ratios of 400, 200, 81, 42, and 29, respectively (Table 2). The final chemical composition of the reaction gel was 1SiO₂/0.25ROH/ 0.25TMAOH/0.5HF/2H₂O plus the required amount of faujasite crystals and 5 wt. % of seed crystals. If the reaction gel was not homogeneous at this stage, the gel was mixed again before transferring into the autoclave. The hydrothermal treatment was carried out at 408 K for 5 days under rotation. In the final step, the samples were calcined to remove the occluded organic SDAs at 823 K for 5 h with ramping rate of 2 K/min. A list of the samples synthesized is summarized in Table 2.

TABLE 2
Amount of faujasite crystals in the synthesis of high-
silica LTA-type zeolites and product properties.

| | Amount of | Si/Al | | Si/Al | Unit | Unit |
|---|---|---|---|---|---|---|
| | Faujasite | ratio in | | ratio in | Cell | Cell |
| | crystals | synthesis | Product | product | size | Volume |
| Run | (wt. %) | gel^{a} | Phase^{b} | (ICP) | Å | Å³ |
| 1 | 15 | 29 | LTA + RUT | — | — | — |
| 2 | 10 | 42 | LTA | 63 | 11.8686(3) | 1671.8(1) |
| 3 | 5 | 81 | LTA | 91 | 11.867(1) | 1671.3(6) |
| 4 | 2 | 200 | LTA | 210 | 11.8574(4) | 1667.1(2) |
| 5 | 1 | 400 | LTA | 420 | 11.855(2) | 1666.1(8) |
| 6 | 0 | ∞ | LTA | — | 11.8521(1) | 1664.9(2) |

^{a}Estimated Si/Al ratio of the synthesis gel calculated by the amount of added faujasite crystals.
^{b}Determined by XRD.

Based on our preliminary experiments, the two key requirements for the reproducible synthesis of high-silica LTA-type zeolites in fluoride media were the addition of seed crystals and the use of faujasite crystals as aluminum source. Seeding is a common method to enhance the crystallization of the target zeolite and has been widely used in the zeolite literature. Without seed crystals, a mixture of pure-silica AST and pure-silica LTA phases (FIG. 8) were obtained. The AST phase, which can be synthesized with julolidine as an SDA, has been often observed as an impurity in the crystallization of pure-silica ITQ-29. The formation of this impurity could be caused by factors such as the presence of impurities in the organic SDA, incomplete ion-exchange of the SDA from I⁻ to OH⁻, and/or insufficient homogenization of the reaction gel. As observed previously, the addition of seed crystals lead to the reproducible synthesis of the pure-silica LTA-type zeolite from siliceous reaction gel. As shown in Table 2, the addition of only 1 wt. % of seed crystals was sufficient and hindered the formation of an AST phase. Therefore, seeding is an effective method for the reproducible LTA-type zeolite synthesis in fluoride media.

Second, for the successful synthesis of the aluminosilicate sample, modification with a suitable aluminum source was necessary besides the seeding. Initially, using aluminum isopropoxide as aluminum source, the product was a mixture of LTA, AST, and RUT phases (FIG. 9). Seeding was applied in all these attempts. Although a small amount of an LTA phase along with an amorphous phase was observed at the early stage of the hydrothermal treatment (3 days), AST and RUT phases became dominant at the end of the crystallization (8 days) (FIG. 9). Although the seed crystals were added to the gel, the crystallization of an LTA phase was not promoted sufficiently and other phases were crystallized. A RUT phase can be synthesized with TMA cation as an SDA, and it is possible that the presence of these undesired phases is caused by local composition inhomogeneities resulting in the unintended nucleation of these phases. To provide aluminum into the system more effectively, zeolites were utilized as the aluminum source, as this is a well-known protocol in hydroxide media. Zeolite crystals added in the synthesis system can be a unique T-atom source; these materials do not work as seeds but give different final product compositions by working as a reactive source of T-atom. On the other hand, this approach has not been investigated in detail in fluoride mediated synthesis. Low silica NH4-form faujasite crystals were effective aluminum sources in LTA-type zeolite synthesis without inducing crystal growth of faujasite or other phases.

Since an aluminosilicate zeolite is not a common aluminum source in fluoride-mediated synthesis, the salient features of their use are described below. These procedures were used not only for the LTA-type zeolite synthesis but also for other zeolite synthesis. First, to prepare a homogeneous reaction gel, the aluminum source zeolite and the seed crystals were added before the gel became very thick by the addition of hydrofluoric acid. Second, the Si/Al ratio of the reaction gel was determined based on the amount of aluminum source zeolite added. Added amount is described in weight % of the total silica formed from TEOS. In the case of LTA-type zeolite synthesis, addition of 1, 2, 5, 10, and 15 wt. % of faujasite crystals resulted in gel Si/Al ratios of 400, 200, 81, 42, and 29, respectively (Table 2). Third, the aluminum source zeolite was added in the NH₄-form, first to avoid contamination by alkaline cations, and second to keep the thermochemical stability low for ease of dissolution. In the case of LTA-type zeolite synthesis, the quasi-siliceous seed crystals were added without calcination because the organic SDAs should stabilize the framework towards dissolution in the concentrated fluoride media. The seed crystal was synthesized from Si-Ge type ITQ-29 crystals (FIG. 1) and contained a very small amount of germanium (Si/Ge=120). The XRD pattern and an SEM image of the seed crystals are shown in FIGS. 2 and 3, respectively. The seed crystals were a highly crystalline form of the LTA-type framework and the particles had cubic morphology with 500 to 800 nm in size.

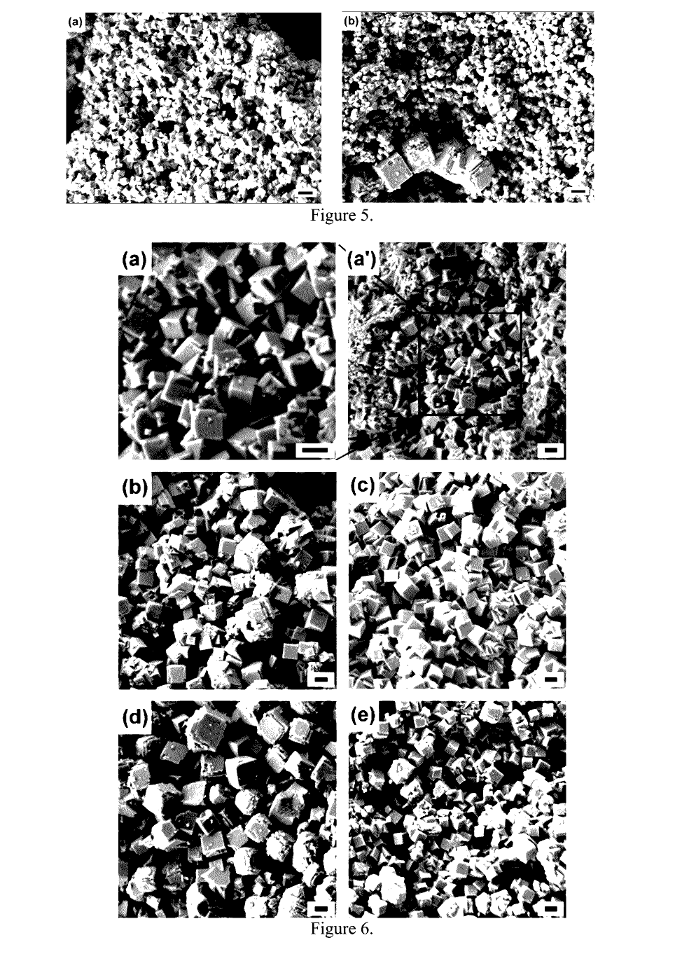

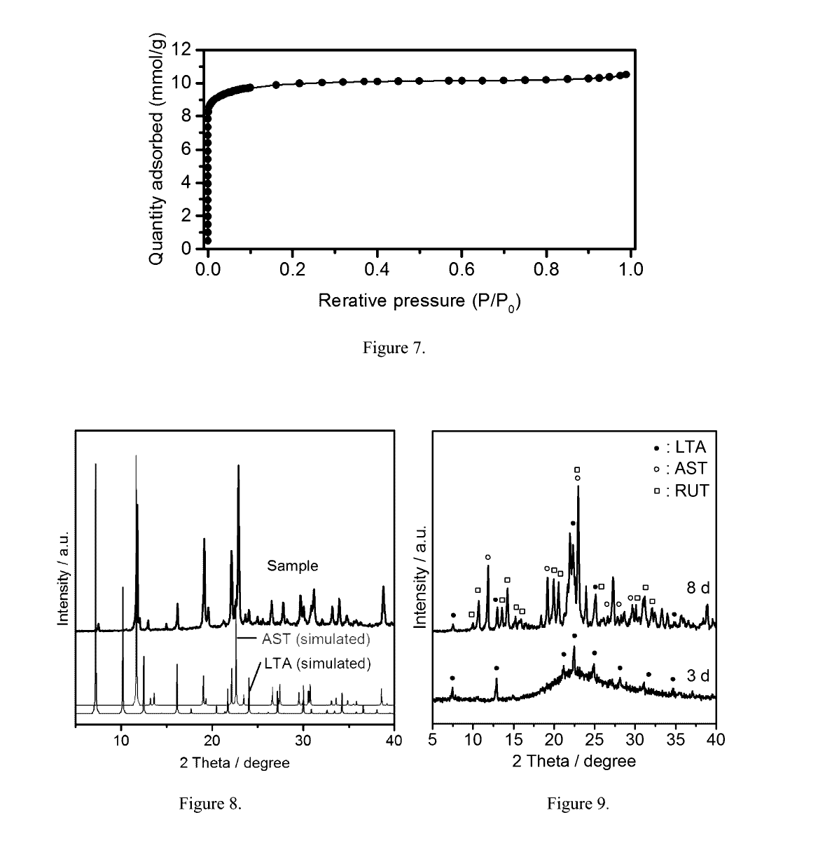

The crystalline phase and morphology of products obtained in the LTA-type zeolite synthesis were characterized by XRD and SEM measurements, respectively. FIG. 4 shows the XRD patterns of the calcined products synthesized with the increasing amounts of faujasite crystals (corresponding to Table 2). Highly crystalline pure-silica and aluminosilicate LTA-type zeolites were synthesized with 0 to 10 wt. % of faujasite crystals, and no other phase, including faujasite, was observed in the XRD patterns of the product (FIG. 4). Although the XRD patterns of these samples showed high crystallinity before and after calcination, the aluminosilicate products synthesized with faujasite crystals were slightly grey (to the naked eye) after calcination at 823 K for 5 hours. With 15 wt. % of faujasite crystals, a small amount of a RUT phase was also observed. FIG. 5 shows the SEM images of the aluminosilicate LTA-type zeolites synthesized with (a) 10 wt. % and (b) 5 wt. % of faujasite crystals. The scale bars in these figures indicate 1 FIG. 6 shows SEM images of the synthesized high-silica LTA-type zeolites synthesized with (a and a′) 10, (b) 5, (c) 2, (d) 1, and (e) 0 wt. % of faujasite crystals. The scale bars in these figures indicate 1 Cubic shaped crystals were observed in each of these images. The size of the crystals was uniform, about 0.5 μm in size regardless of aluminum content in the reaction gel, but larger crystals (1 to 2 μm) were sometimes observed as shown in FIG. 6(b). The Si/Al ratios of the final products determined by ICP measurements correlate linearly with that of reaction gels, ranging from 63 to 420 (see Table 2). The lowest Si/Al of 63 was synthesized with the addition of 10 wt. % of faujasite crystals. Nitrogen adsorption isotherm of the sample with Si/Al ratio of 63 showed type I (FIG. 7) and the micropore volume was 0.23 cm³g⁻¹ as determined by the t-plot method. This value is comparable to the micropore volume of ITQ-29 reported previously, 0.24 cm³g⁻¹. As indicated above, the calcined aluminosilicate LTA-type zeolite synthesized with 10 wt. % of faujasite crystals showed grey color, which would be caused by the remaining carbon species in the micropore; these adsorption measurements, however, reveal that micropore access was not blocked by the remaining carbon.

Similar crystal sizes and morphologies of aluminosilicate LTA-type zeolites with different Si/Al ratio were observed, suggesting, indirectly, that the nucleation and crystal growth rates were not affected. The lowest Si/Al ratio of the reaction gel for the successful synthesis was about 42 (10 wt. % of faujasite crystals, Table 2), which is similar to the value found previously, Si/Al ratio of 50. This limit may originate from the charge balance needed between SDA cations, fluoride anions, and charged aluminum sites.

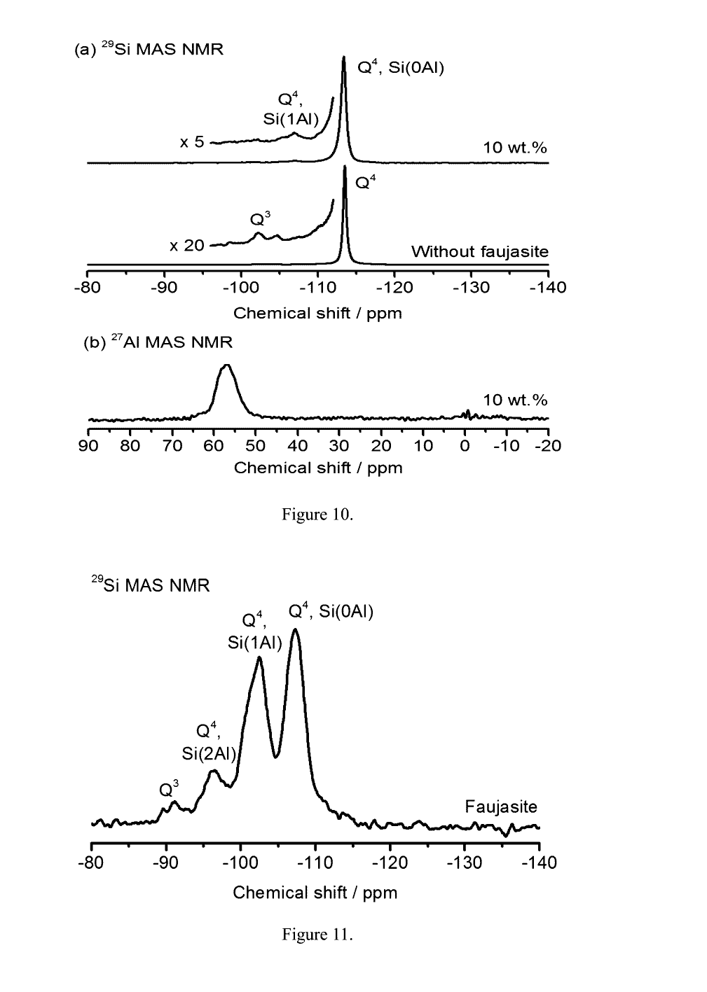

FIG. 10 shows the solid-state (a) ²⁹Si and (b) ²⁷Al MAS NMR spectra of the pure-silica and aluminosilicate (synthesized with 10 wt. % of faujasite, Si/Al=61) LTA-type zeolites. In the case of the pure-silica sample, the ²⁹Si NMR spectrum showed a strong signal at −113 ppm, which corresponds to Q⁴ ((SiO)₄Si) species. The signals at around −103 ppm, corresponding to Q³ ((SiO)₃SiOH or (SiO)₃SiO⁻) species, were very weak, (magnified spectrum is inserted in FIG. 10) indicating that the product contains almost no internal defect sites (T-vacancies or silanol nests). In the case of the aluminosilicate sample, two Q⁴ signals were observed at −107 and −113 ppm corresponding to Si(1Al) and Si(0Al) species, respectively. Again, the signal from Q³ species was very weak, indicating the aluminosilicate LTA-type zeolite obtained also has a nearly defect-free structure. The presence of Si(1Al) species indicates that a fraction of the silicon atoms are connected to aluminum atoms via oxygen atom. No signals assigned to faujasite crystals were observed in −90 to −108 ppm region (FIG. 11). Solid-state ²⁷Al MAS NMR of the aluminosilicate LTA sample showed a single signal at 57 ppm (FIG. 10), indicating the aluminum atoms were tetrahedrally coordinated and were incorporated in the zeolite framework successfully, and no signal corresponding to extra-framework octahedrally coordinated aluminum species were observed at around 0 ppm.

The chemical shift of ²⁹Si MAS NMR signal is unique to each zeolite due to their unique framework features such as the average T-O-T angle for each T-atom. Pure-silica ITQ-29 has crystallographically a single T-site in the asymmetric unit, and results in the single Q⁴ signal in NMR spectrum (FIG. 10(a)). One notable difference from conventional LTA-type zeolites synthesized in hydroxide media is the nearly defect-free structure. A very small fraction of defect sites is one of the characteristic features of the fluoride-mediated synthesis, because the fluoride anion compensates the charge of SDA cation during the synthesis (as opposed to SiO⁻, siloxy groups,). For the aluminosilicate sample (synthesized with 10 wt. % of faujasite crystals), the Si/Al ratio calculated from the peak ratio of Si(1Al) and Si(0Al) signals is about 87, which is a little higher than the results of ICP measurement (Si/Al ratio=63, Table 2). The signal from Si(2Al) sites was not observed, because the obtained sample has high Si/Al ratio, and there is little chance for one Si atom to connect two Al atoms. On the other hand, the signal of Si(2Al) sites at −97 ppm was observed in faujasite crystals (FIG. 11), because at the low Si/Al ratio of 2.47 some Si atoms are connect to two Al atoms. These characterization results indicate that the added faujasite crystals were completely dissolved during hydrothermal treatment and all aluminum atoms supplied from faujasite crystals, at this level of substitution, were successfully incorporated in the LTA-type framework.

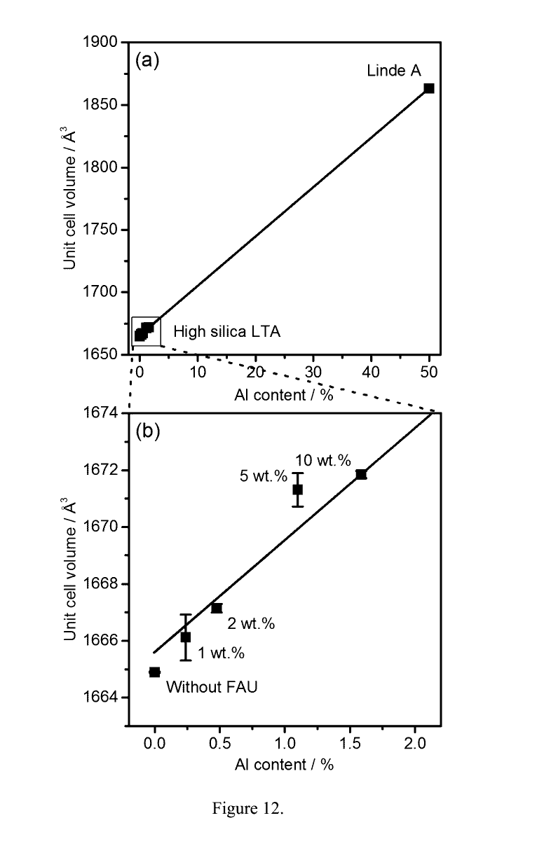

The unit cell dimensions of the samples further confirm the incorporation of the aluminum atoms into the framework of high-silica LTA-type zeolites. Due to the difference in bond angle and bond length between Si—O—Si and Al—O—Si, unit cell parameters change along with the Si/Al ratio. In FIG. 12, calculated unit cell volumes of the samples were plotted against the aluminum content. The space group Pm3m was used (recall that LTA-type framework has cubic symmetry) and the unit cell parameter a and the unit cell volume were refined (see Table 2). As a reference, the unit cell volume of zeolite A (Linde A, Si/Al ratio=1) was also calculated and plotted in FIG. 12(a). The zeolite Linde A was a commercial zeolite 4A (Na-form, Aldrich). The line shown in these figures represents the linear fitting line of the six points. The calculated points showed good fit to the line, and the unit cell volume was proportional to the aluminum content. This result indirectly indicates that the aluminum atoms supplied from faujasite crystals were successfully incorporated in the LTA-type framework. Moreover, the unit cell information collected by XRD measurement can be useful to estimate the Si/Al ratio of samples of unknown chemical composition. The unit cell volume of pure-silica ITQ-29 was reported to be 1671.2 A³. Although the value is slightly larger than that of our pure-silica sample synthesized without faujasite crystals (1664.9 A³), the difference can be the result of the offset of the instrument and the refinement method.

### Example 5

### Synthesis of the High-Silica ITW-Type Zeolite

High-silica ITW-type zeolite was synthesized by adding small amount of aluminosilicate faujasite crystals into the synthesis procedure of pure-silica ITW-type zeolite, ITQ-12. 1,2,3-Trimethyl-imidazolium hydroxide (TMIOH) was used as the organic SDA. First TEOS, a silicon source, was hydrolyzed in a solution of organic SDA hydroxide under stirring at room temperature for 3 hours. After hydrolysis of TEOS, a small amount of as-made pure-silica seed crystals (1 wt. % of the total silica formed from TEOS) and the NH₄-form faujasite crystals (5 wt. % of the total silica formed from TEOS) was added to the solution and stirred for 1 h. Hydrofluoric acid (HF) was then added to the mixture, and stirred by hand with a spatula. The homogenized gel was placed in an oven at 353 K to adjust the H₂O/Si₂O ratio. The final chemical composition was 1SiO₂/0.5TMIOH/0.5HF/12H₂O plus the required amount of faujasite crystals and 1 wt. % of seed crystals. The hydrothermal treatment was carried out at 448 K for 7 days under rotation. The samples were filtered, washed with DI water, and dried in air in an oven at 353 K. The samples were calcined in air to remove the occluded organic SDAs at 823 K for 5 hours.

### Example 6

### Synthesis of High-Silica CHA-, *BEA-, and STT-Type Zeolites

High-silica CHA- and STT-type zeolites were synthesized using N,N,N-trimethyl-1-adamantanammonium hydroxide (TMAdaOH, 25% aqueous solution) as the organic SDA. High-silica *BEA-type zeolite was synthesized using tetraethylammonium hydroxide (TEAOH, 35% aqueous solution) as the organic SDA. The as-received Na-form of mordenite (Si/Al ratio=5) and Linde A (Si/Al ratio=1, Zeolite 4A) were ion-exchanged into their NH₄-forms prior to use as aluminum source. Five grams of the zeolite crystals were stirred in 300 ml of ammonium nitrate solution (0.2 M) at room temperature for 1 day and subsequently filtered, washed with DI water and dried. To prepare the zeolites, TEOS was hydrolyzed in a solution of organic SDA hydroxide under stirring at room temperature for 3 hours. After hydrolysis of TEOS, a small amount of as-made pure-silica seed crystals (1 wt. % of the total silica formed from TEOS) and the NH₄-form zeolite crystals (faujasite, mordenite, or Linde-type A; 5 to 15 wt. % of the total silica formed from TEOS) was added to the solution and stirred for 1 h. Then HF was added to the mixture, and the resultant gel stirred by hand with a spatula. The homogenized gel was placed in an oven at 353 K to adjust the H₂O/Si₂O ratio.

The final chemical compositions of the gel for CHA-, *BEA-, and STT-type zeolite are summarized in Table 2. The synthesis was carried out with seed, aluminum source and zeolite crystals. The hydrothermal treatment for CHA-type zeolite was carried out at 423 K for 3 days under rotation, for *BEA-type zeolite was carried out at 413 K for 3 days under rotation, and for STT-type zeolite was carried out at 448 K for 3 days under rotation. The samples were filtered, washed with DI water, and then dried in air in an oven at 353 K. The samples were calcined in air to remove the occluded organic SDAs at 823 K for 5 hours.

### Example 7

### Faujasite Crystals as Aluminum Source in LTA-Type Zeolite Synthesis

The example described the use of an aluminosilicate zeolite as an alumina source us a fluoride media. Faujasite crystals were used as additional T-atom sources but not as seeds. This methodology has been used in a number of zeolite syntheses in hydroxide media. Moreover, zeolites have also been used as precursors for interzeolite conversion (or called interzeolite transformation), in which the precursor zeolite converts into another zeolite phase under hydrothermal conditions without adding other T-atom sources. These studies show that zeolites can be a unique T-atom sources. Recently, high-silica LEV-type zeolite was successfully synthesized in fluoride media via zeolite conversion approach. The advantages of the use of a zeolite as a T-atom source are: (1) a continuous slow feeding of T-atom into the reaction mixture during the hydrothermal treatment due to its higher stability, and (2) the presence of pre-formed aluminosilicate networks or small units in the dissolved aluminosilicate species originated from the mother crystals. A similar hypothesis has been suggested in the aging process of zeolite synthesis, in which specific pre-formed aluminosilicate networks induce the nucleation of the target zeolite phase. Although it is difficult to find direct evidence for these ideas, zeolite crystals have been experimentally used as effective T-atom sources or precursors in several cases. Different zeolites were used as both seeds and T-atom sources in the present study, and as shown above, the solubility or stability of each zeolite phase in the synthesis gel need to be considered for a successful synthesis.

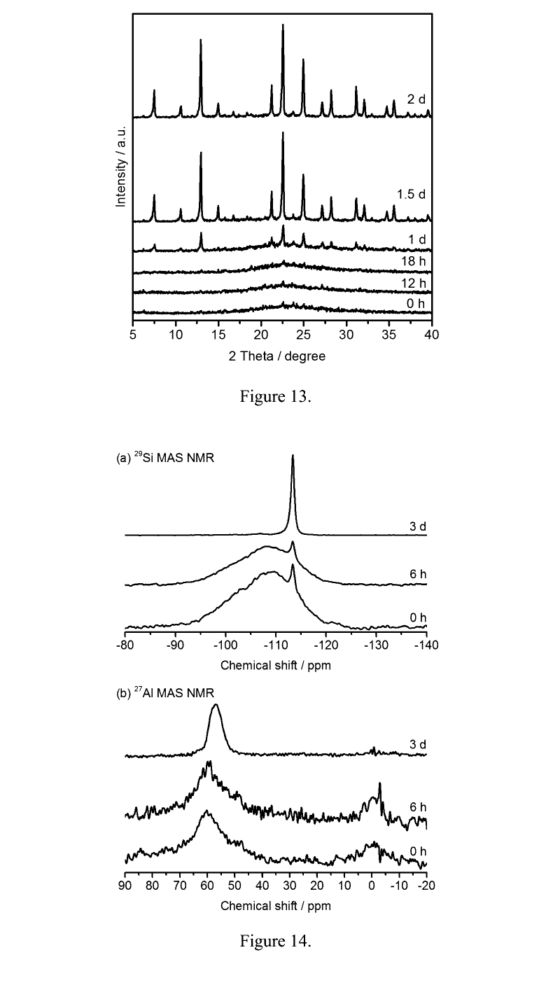

The crystallization of the aluminosilicate LTA sample was investigated in more detail for the sample synthesized with 10 wt. % of faujasite crystals. FIG. 13 shows the XRD patterns of as-made samples synthesized with different hydrothermal reaction time. The crystalline LTA phase was clearly observed after one day of hydrothermal reaction, and the crystallization was completed after 12 additional hours (total of 1.5 days). Up to 18 hours, only a small peak at 22.5° with a broad peak at 23° can be recognized, indicating the presence of a small amount of LTA-type crystals and an amorphous phase, respectively. No FAU phase was recognizable by XRD even at the initial stage of reaction (0 h) although as much as 10 wt. % of the faujasite crystals were added. These results indicate that the faujasite crystals dissolved, or at least lost their crystalline structure, at the very early stage of the synthesis process.

The stability of zeolite crystals was confirmed by ²⁹Si and ²⁷Al solid-state MAS NMR measurements (FIGS. 14(a) and 14(b), respectively). The sample before hydrothermal reaction (with 0 h of hydrothermal treatment time) showed two main ²⁹Si NMR signals; a broad signal at −109 ppm and sharp signal at −113 ppm corresponding to amorphous silica and quasi-siliceous LTA-type seed crystals, respectively (FIG. 14(a), 0 h). No signals corresponding to faujasite crystals were observed in the ²⁹Si MAS NMR spectrum, as was the case with the XRD patterns. With the progress of the hydrothermal treatment, the relative intensity of the NMR signal from seed crystal (at −113 ppm) decreased (FIG. 14(a), 6 h). Finally, however, the spectrum shows a strong signal at −113 ppm and a very weak signal at −107 ppm indicating that all the silicon atoms were incorporated in LTA structure (FIG. 14(a), 3 d). The ²⁷Al NMR spectrum shows the presence of both tetrahedrally and octahedrally coordinated aluminum atoms at 60 and 0 ppm, respectively, on the sample with 0 h of hydrothermal treatment (FIG. 14(b), 0 h). Octahedrally coordinated aluminum atoms are usually assigned to extra-framework aluminum species and this observation is an indication of the partial decomposition of faujasite crystals. After 6 hours of hydrothermal treatment, the fraction of octahedrally coordinated aluminum atoms increased slightly (FIG. 14(b), 6 h), indicating that the decomposition of faujasite crystals has continued. The chemical shifts of the aluminum atoms in the sample (²⁷Al MAS NMR) were different in each zeolite due to their structural properties: around 58 ppm for aluminoslicate LTA-type zeolite and around 60 ppm for faujasite. Therefore, the tetrahedrally coordinated aluminum atoms observed in the early stage of hydrothermal treatment (0 and 6 hours) are aluminum atoms incorporated in faujasite framework. In the end, the ²⁷Al MAS NMR spectrum shows only a single signal at 57 ppm, indicating that all the aluminum atoms were tetrahedrally coordinated in LTA framework and almost no extra-framework aluminum are present (FIG. 14(b), 3 d).

It is concluded that the quasi-siliceous seed crystals maintained their structure throughout the synthesis procedure, but the faujasite crystals (aluminum source) were dissolved early during the synthesis protocol. Low-silica zeolites are thermodynamically less stable than high-silica zeolites, in general, and this agrees with expectations. However, the added faujasite crystals already decomposed before the hydrothermal treatment in the process described herein. This might be possible because, in the gel preparation process used, the zeolite crystals were added into a fluoride mediated solution and then the gel was heated in an oven at 80° C. for several hours to adjust the H₂O content. Therefore, if the stability of the zeolite was not high enough, the crystalline phase can be dissolved during this heating process. Faujasite crystals were added as the less-stable NH₄-form, and their low Si/Al ratio framework also leads to a less stable material under severe reaction conditions. The decomposition of faujasite and/or the reconstruction of aluminosilicate network can proceed during the gel preparation process, and no peaks and no signals were detected in XRD and NMR measurements, respectively. Moreover, the increase of octahedrally coordinated aluminum atoms after 6 hours of hydrothermal treatment indicates that the decomposition and/or reconstruction of aluminosilicate network proceeds under the hydrothermal treatment. LTA seed crystals, on the other hand, were stable enough to resist dissolution by the gel preparation process. During the hydrothermal treatment, seed crystals were also dissolved (to some extent) as shown by the decrease of the ²⁹Si NMR signal at −113 ppm, but most of the LTA crystals must retain their structure as seeds. Here, the difference of the hydrothermal stability between faujasite and LTA crystals was used effectively to use one phase as an aluminum source and the other as a seed.

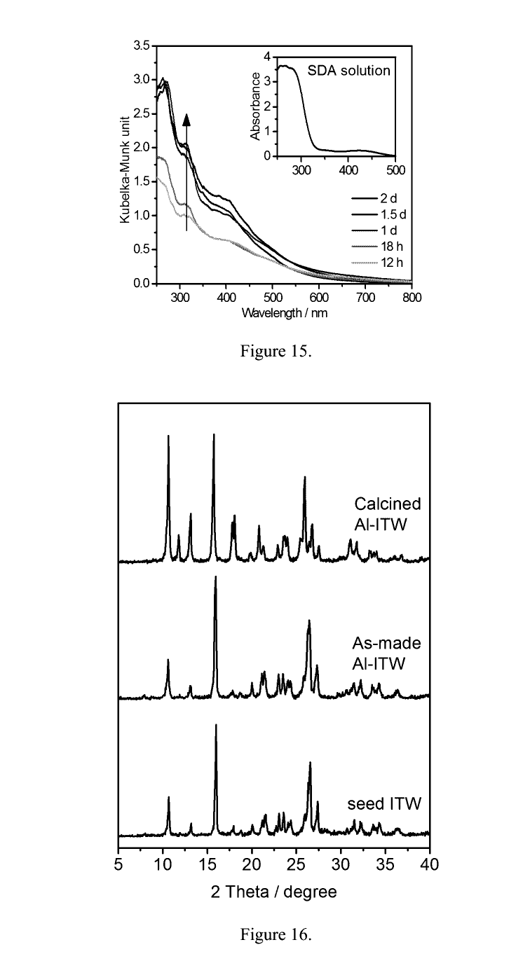

Finally, formation of the LTA structure was also confirmed in terms of the amount of the incorporated organic SDA. FIG. 15 shows UV-vis spectra of the as-made samples synthesized with different hydrothermal reaction times corresponding to FIG. 15. Regardless of the crystallization time, all the samples showed electronic transitions at around 310 and 410 nm. The peak at 310 nm corresponds to the formation of the dimers of supramolecular methylated-julolidine molecules. The presence of the dimers was confirmed even in the early stage of the hydrothermal treatment at 12 h, at which no crystalline phase was observed (FIG. 15). The formation of dimers does not necessarily indicate formation of a cage structure or incorporation of the organic SDA inside the aluminosilicate framework. The dimers are easily formed in concentrated aqueous conditions, as was confirmed in the insert in FIG. 15. Therefore, dimers of SDA, had been already formed just after the gel preparation process because of the low water content. The remarkable difference is the absorption intensity, which reflects the concentration of the organics. Before the UV-vis measurements, the samples taken out from autoclaves were filtered and washed with DI water several times. The organics adsorbed on the sample surface should be easily removed by washing because the interaction between the organics and the aluminosilicate frameworks is weak. On the other hand, if the organic dimers were occluded in a-cages, they would be hardly removed by the washing process. After 1 day of hydrothermal treatment, the concentration of the dimers was significantly higher than that before 18 hours (FIG. 15). This result indicates that a large amount of organic dimers was occluded in α-cages after 1 day of hydrothermal treatment, suggesting the formation of LTA-based cage structures. This is in good agreement with the XRD result, in which the apparent formation of small amount of an LTA phase was observed after 1 day of hydrothermal treatment (FIG. 13).

### Example 8

### Synthesis of Aluminosilicate ITW-Type Zeolites in Fluoride Media

High-silica ITW-type zeolite was previously known only in its pure-silica form (ITQ-12). Aluminosilicate ITW-type zeolite with Si/Al ratio of 71 was synthesized by using 5 wt. % of faujasite crystal as aluminum source. This is the first time that the synthesis of an aluminosilicate ITW-type zeolite has been reported. Based on the previous report, 1,2,3-trimethylimidazolium appeared to be the strongest SDA in the ITQ-12 synthesis, and the same organic SDA was used in the reaction gel to prepare in the aluminosilicate ITW-type zeolite. Pure-silica ITQ-12 seed crystals were used to facilitate the crystallization, and 1 wt. % of the seed crystals were added without calcination.

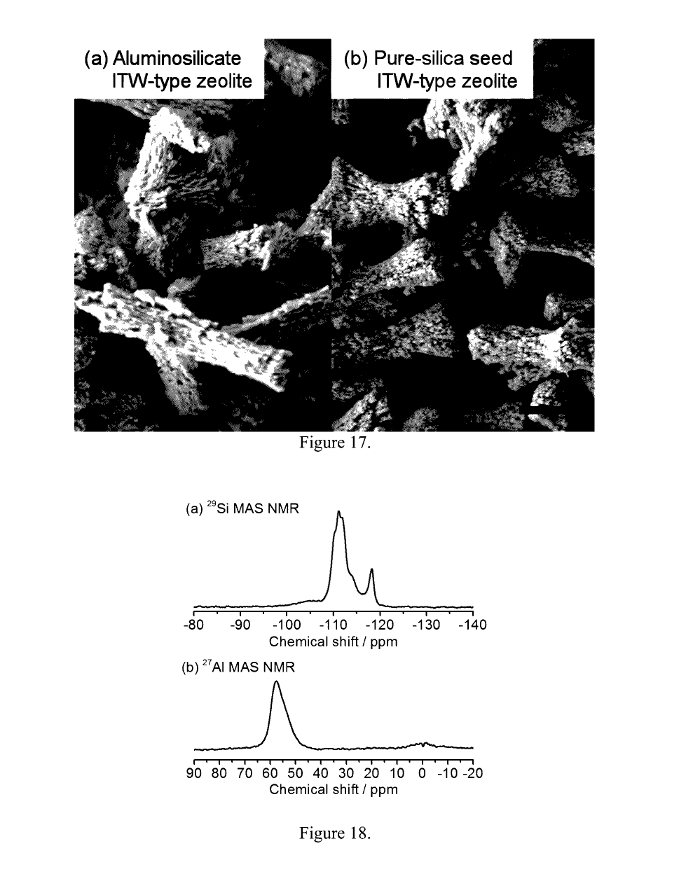

FIG. 16 shows the XRD patterns of the as-made pure-silica seed and the synthesized aluminosilicate product before and after calcination. Highly crystalline aluminosilicate ITW-type zeolite was synthesized with 5 wt. % of faujasite crystals, and no other phase, including faujasite, was observed in the XRD pattern (FIG. 16). The 2-theta angle peak positions of the synthesized aluminosilicate crystals were slightly shifted to lower angles from that of pure-silica seed crystals, indicating a larger unit cell dimension and suggesting the incorporation of aluminum atom into the framework. The crystalline structure was maintained after the calcination at 823 K for 5 hours without decomposition to an amorphous phase, and a change of relative peak intensities was observed due to the removal of occluded SDAs (FIG. 16). The Si/Al ratio of the aluminosilicate crystals was 71 as measured by EDX, almost same as that of synthesis gel (Si/Al ratio of 78). The SEM images of pure-silica seed and aluminosilicate ITW-type zeolites are shown in FIG. 17, where the scale bars in the figures indicate 2 μm. In both cases, rod-like crystals of about 100 to 300 nm in length aggregate to form large agglomerates of about 4 to 5 μm in size. The N₂ adsorption isotherms of aluminosilicate and pure-silica ITW-type zeolites showed typical type-I isotherm (FIG. 22), and the micropore volumes of the samples determined by the t-plot method were 0.17 and 0.19 cm³/g, and BET surface areas were calculated as 373 and 392 m²/g, respectively. These results indicate that the aluminosilicate ITW-type zeolite obtained has similar structural properties to the pure-silica ITW-type zeolite.

When the amount of faujasite was increased to 10 wt. % to increase the aluminum content, the crystallization of an ITW phase becomes slow and it was not completed in 7 days of hydrothermal treatment (data not shown). After 21 days, a mixture of a material having a TON framework structure and an unidentified phase became dominant in the product. At this point, 5 wt. % is the upper limit of faujasite crystal that can be added for a successful synthesis of aluminosilicate ITW-type zeolite. TON-type zeolites, such as theta-1 and ZSM-22, sometimes compete in the synthesis of pure-silica ITQ-22. It has been shown previously that a TON phase transforms, in situ, into an ITW phase under certain conditions with specific organic SDAs. This suggests that an ITW phase would be thermodynamically more stable than a TON phase. It would be possible that the TON phase obtained in our synthesis would transform into an ITW phase after longer hydrothermal treatment. The process, however, would be very slow (more than 3 weeks under hydrothermal treatment at 175° C.). Further adjustment of the chemical composition of the gel and synthesis parameters are needed to obtain an aluminosilicate ITW-type zeolite with lower Si/Al ratio.

The successful introduction of aluminum atom into the ITW framework is confirmed by solid-state ²⁹Si and ²⁷Al MAS NMR measurements (FIG. 18). The silicon NMR spectrum shows several overlapped signals (FIG. 18(a)), and it is difficult to assign these complicated signals to each silicon sites with certainty. A previous report shows that the ²⁹Si MAS NMR spectrum of calcined ITQ-12 (pure-silica ITW-type zeolite) has five signals between −108 to −118 ppm, corresponding to crystallographically different Q⁴ framework sites. If aluminum atoms are incorporated in the framework, the signal from Si(1Al) site should appear in a higher chemical shift region. Several overlapped peaks at −108 to −118 ppm region, and a small shoulder at −105 ppm (FIG. 18(a)) were observed that had not been observed in the pure-silica sample. The shoulder is assigned to an aluminum-connecting Q⁴ silicon atom, Si(1Al), or perhaps it could be assigned to a Q³ silicon atom (indicating structural defects). To establish that the sample has less structural defects, the cross-polarization ²⁹Si MAS NMR measurement was performed (FIG. 23). The spectrum does not show any remarkable signal at −105 ppm and therefore the small shoulder was assigned to a Si(1Al) site. Although the deconvolution of the complicated signal remains incomplete, the Si/Al ratio was estimated to be about 100 from the peak ratio of Si(1Al) and Si(0Al) signals, a value that is higher than that measured by EDX. The major signals at around 57 ppm in ²⁷Al MAS NMR spectrum showed that aluminum atoms are tetrahedrally coordinated. Note that the chemical shift of the observed signal is different from that of faujasite. A small, minor signal observed at 0 ppm, indicates the presence of a very small fraction of extra-framework aluminum atoms. Based on these results, it is concluded that the obtained aluminosilicate ITW-type zeolite has a nearly defect-free structure and most of the aluminum atoms supplied from faujasite crystals are successfully incorporated in the ITW-type framework.

### Example 9

### Aluminosilicate Zeolites as Aluminum Sources for Other Fluoride Mediated High-Silica Zeolite Syntheses.

High-silica CHA, *BEA, and STT-type zeolites were synthesized using low-silica zeolites as an aluminum source via fluoride mediated synthesis. Although these zeolites have been already reported as aluminosilicate and pure-silica zeolites, the success of the syntheses shows the wide applicability of this methodology for the preparation of high-silica zeolites in fluoride syntheses. The synthesis procedure was almost the same as in the case of LTA and ITW-type zeolites, except for different organic SDAs and chemical compositions in the synthesis gel. Synthesis conditions and some product properties are summarized in Table 3. A small amount of as-made pure-silica seed (1 wt. %) was added to fasten the crystallization and a specific amount (5 to 15 wt. %) of a low-silica zeolite as an aluminum source. Not only faujasite but also mordenite and Linde type A were used as aluminum sources. The Na-form of the zeolites was ion-exchanged to the NH₄-form to lower the materials stability under hydrothermal condition. Moreover, sodium cations could induce undesired nucleation of other zeolites as an inorganic SDA.

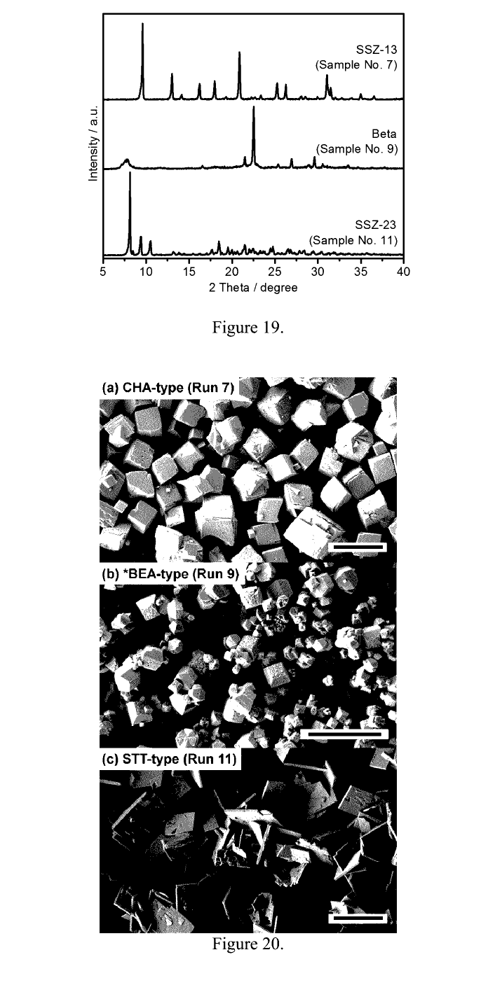

FIGS. 19 and 20 show the representative XRD patterns and SEM images of the high-silica CHA-, *BEA-, and STT-type zeolites obtained (Runs 7, 9, and 11, respectively). All the peaks of the XRD patterns were indexed to CHA, *BEA, and STT phases (FIG. 19), and no other zeolite phase, such as faujasite or mordenite, was observed in any cases. They all showed high crystallinity and the structures remained stable after the calcination at 823 K for 5 hours. The morphologies and sizes of the aluminosilicate crystals were confirmed by SEM measurements (FIG. 20). The scale bars in the figures indicate 10 μm. The morphologies and sizes of the aluminosilicate crystals are comparable to the conventional pure-silica products synthesized in fluoride media. Crystal sizes were much larger, in the micron size, than the ones synthesized in hydroxide media. The Si/Al ratios of the final products were estimated by EDX (Table 3), and they were roughly proportional to the amount of added low-silica zeolites. The Si/Al ratios of the CHA- and *BEA-type zeolites were similar to those of reaction gels, on the other hand the STT-type zeolites showed remarkably higher Si/Al ratios than their reaction gels (Runs 11 and 12).

The micropore volumes (Table 3) determined from the N₂ adsorption isotherms (FIG. 26) by t-plot method are comparable to those of the zeolites synthesized in a conventional hydrothermal method.

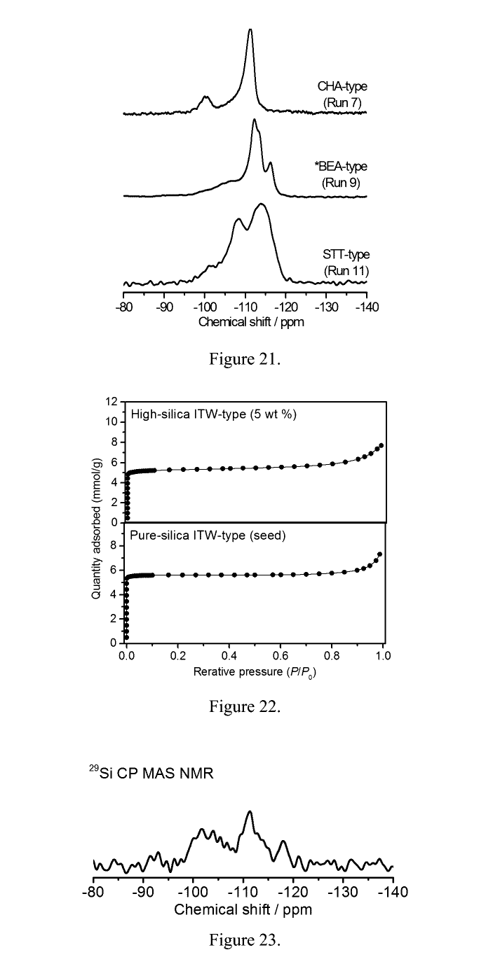

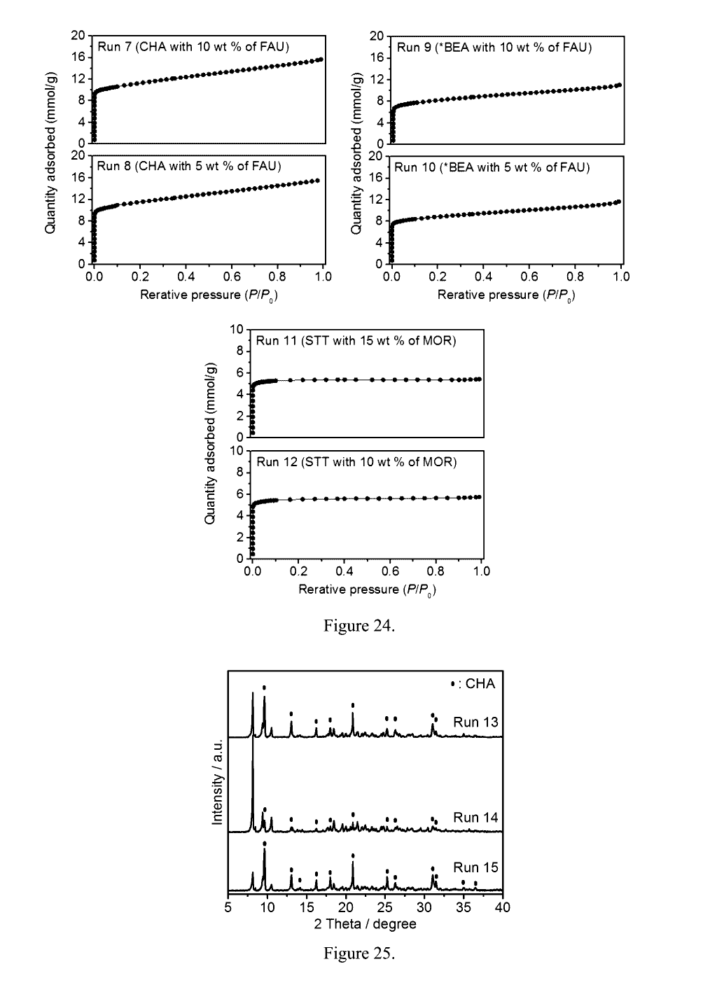

FIG. 21 shows the solid-state ²⁹Si MAS NMR spectra of the samples 7, 9, and 11, corresponding to the samples in FIGS. 19 and 20. The chemical shifts of the NMR signals depend on each zeolite framework type, and they are assigned to CHA-, *BEA-, and STT-type frameworks. In the case of CHA-type zeolite (sample 7), signals at around −100, −105, and −110 are assigned to Q⁴ Si(2Al), Si(1Al), and Si(0Al) sites, respectively. The defect site (Q³ site) also has a chemical shift at −100 ppm and overlaps with the Si(2Al) signal. The simulated spectrum of ideal high-silica CHA-type zeolite (Si/Al ratio of 50) does not show a signal at −100 ppm, suggesting that the observed signal in this region is probably originated from defect sites. The concentration of the defect sites, however, is as small as the previous high-silica CHA-type zeolite synthesized in fluoride media. *BEA- and STT-type zeolites also show signals from Q⁴ and Q³ sites (FIG. 21). The Q⁴ signals of *BEA- and STT-type zeolite are observed at around −110 to −118 ppm and around −105 to −120 ppm, respectively. Small signals due to defect sites are also observed on the shoulder of main signals at around −100 ppm in both cases. The concentrations of defect sites of these samples are also comparably small to previous reports. The results of NMR studies indicate that the products synthesized have fewer defect sites than the product synthesized in hydroxide media. Therefore, the obtained high-silica aluminosilicate zeolites may show hydrophobic properties and may be useful in a number of applications.

In the case of an STT-type zeolite, the type of zeolite used as aluminum source affected the final product, and mordenite was the only aluminum source that led to a single STT phase (Table 3). The effect of the framework type and Si/Al ratio of the low-silica zeolite used as an aluminum source was investigated. With the use of faujasite or zeolite A crystals, the crystallization of CHA-type zeolite was induced besides STT-type zeolite (Runs 13, 14, and 15) (FIG. 27). In these cases, it was not clear whether the obtained STT-type zeolite contained aluminum atoms in the framework or not. In general, CHA and STT phases are synthesized under very similar synthesis conditions. Therefore, even in the presence of STT-type seed crystals, the nucleation of a CHA phase may be induced by other factors such as the changes in local gel composition. Moreover, faujasite has been a common T-atom source used in the synthesis of aluminosilicate CHA-type zeolite. CHA-type zeolite impurities were always present when zeolite A was used as the source of aluminum. A single STT phase was obtained only when using mordenite as an aluminum source (Table 3).

TABLE 3
Synthesis parameters of high-silica zeolites and some product properties.

| | | | Amount | Si/Al ratio | | Si/Al ratio | |
|---|---|---|---|---|---|---|---|
| | Desired | Aluminum | of zeolite | of the | | of the | Micropore |
| | Product | source | crystals | synthesis | Product | product | volume |
| Run | (seeds) | (Si/Al ratio) | (wt. %) | gel^{a} | Phase^{b} | (EDX) | cm³g⁻¹ |
| 7 | CHA | Faujasite (2.47) | 10 | 40 | CHA | 55 | 0.25 |
| 8 | CHA | Faujasite (2.47) | 5 | 78 | CHA | 76 | 0.26 |
| 9 | *BEA | Faujasite (2.47) | 10 | 40 | *BEA | 44 | 0.19 |
| 10 | *BEA | Faujasite (2.47) | 5 | 78 | *BEA | 65 | 0.22 |
| 11 | STT | Mordenite (5) | 15 | 47 | STT | 85 | 0.17 |
| 12 | STT | Mordenite (5) | 10 | 68 | STT | 11 | 0.18 |
| 13 | STT | Faujasite (2.47) | 10 | 40 | SST + CHA | — | |
| 14 | STT | Faujasite (2.47) | 5 | 78 | STT + CHA | — | |
| 15 | STT | Zeolite A (1) | 5 | 47 | STT + CHA | — | |

^{a}Estimated Si/Al ratio of the synthesis gel calculated by the amount of added zeolites.
^{b}Confirmed by XRD patterns.
c: Confirmed by EDX measurements.

The apparent differences between the faujasite, zeolite A, and mordenite were Si/Al ratios and framework structures. Although the overall reactant gel composition is same, these differences would effect on the local Si/Al ratio in the gel, relative solubility in fluoride media, and/or the “precursor” formation prior to the crystallization. Therefore, appropriate aluminosilicate zeolites should be selected as aluminum source for the successful synthesis.

1. A method of producing a high-silica target zeolite having a desired framework structure and a silica to alumina ratio (SAR) of at least about 30, the method comprising adding quasi-siliceous seed crystals of a zeolite having the desired framework structure to a fluoride containing gel comprising a structure directing agent (SDA), an alumina source, and a silica source, where the alumina source is a second zeolite having a different framework than the target zeolite and the alumina source become incorporated into the framework of the high-silica target zeolite.

2. The method of claim 1, where the quasi-siliceous seed crystal comprises Si, Ge, Al or a combination of two or more thereof.

3. The method of claim 2, where the quasi-siliceous seed crystal comprises silicon and germanium in a ratio of 2:1 or greater.

4. The method of claim 1, where the quasi-siliceous seed crystal comprises a framework selected from the group consisting of AEI, AFX, *BEA, CHA, IFY, ITW, LTA, STT, and RTH.

5. The method of claim 4, where the quasi-siliceous seed crystal comprises a structure directing agent.

6. The method of claim 1, where the second zeolite comprises a low or intermediate SAR.

7. The method of claim 6, where the second zeolite comprises a framework selected from the group consisting of GME, FAU, MOR and LTA.

8. The method of claim 1, where the second zeolite has been ion-exchanged with alkali metal ions, ammonium ions, alkyl ammonium ions or hydrogen ions, preferably ammonium ions.

9. The method of claim 1, where the amount of the aluminum source is ≦25% by weight of the total amount of silica in the gel.

10. The method of claim 1, where the high-silica target zeolite has a silica to alumina ratio (SAR) of about ≧20.

11. (canceled)

12. A composition comprising a high-silica zeolite having a silica to alumina ratio (SAR) of about 80 to about 500 and a framework structure selected from IFY, ITW, and RTH.

13. A composition comprising a high-silica zeolite having an SST framework and a silica to alumina ratio (SAR) of about 120 to about 1000.

14. A composition comprising an aluminosilicates zeolite having an LTA framework and a silica to alumina ratio (SAR) of about 25 to about 45.

15. (canceled)
